(19) United States
(12) Patent Application Publication
(10) Pub. No.: US 2023/0214681 A1
(43) Pub. Date: Jul. 6, 2023

(54) Model Decisions Based On Speculative Execution

(71) Applicant: Amazon Technologies, Inc., Seattle, WA (US)

(72) Inventors: Homer Strong, Seattle, WA (US); Yigitcan Kaya, Hyattsville, MD (US)

(21) Appl. No.: 17/209,782

(22) Filed: Mar. 23, 2021

(51) Int. Cl. G06N 5/04; G06N 20/00

(52) U.S. Cl. CPC G06N 5/04; G06N 20/00

(57) ABSTRACT

A machine learning model may generate a first recommendation relating to allocation of a first permission to an identity, wherein the first recommendation is a recommendation for the identity to retain the first permission or a recommendation to deallocate the first permission from the identity. A first indication of the first recommendation may be provided to one or more users. The machine learning model may, based on speculative execution, determine a first condition that, when attributed to the identity, causes changing of the first recommendation to a second recommendation relating to the allocation of the first permission to the identity, wherein the second recommendation differs from the first recommendation. A second indication may be provided, to the one or more users, that attribution of the first condition to the entity causes the changing of the first recommendation to the second recommendation.

### CROSS-REFERENCE TO RELATED APPLICATIONS

This application is related to the following application: U.S. patent application Ser. No. 17/107,082 filed Nov. 30, 2020, entitled “FORECAST-BASED PERMISSIONS RECOMMENDATIONS” (Attorney Docket Number: 101058.001064).

### BACKGROUND

Access to computing services and resources may be managed through an identity management service, which may allow customers to create identities (e.g., users, groups, roles, etc.) and allocate permissions to the identities. In some examples, permissions for an identity may be defined by attaching a policy to the identity, and the policy may define permissions that are allocated to the identity. The principle of least-privilege is a cornerstone of security that specifies that each identity should only have permission to access the services that it needs to perform its specific tasks. Restricted permissions limit the potential impact of a compromised identity. In practice, however, configuring permissions correctly is time-consuming and error-prone. It is rare to know exactly which permissions are necessary in advance. Thus, customers may often allocate more permissions than necessary to an identity. For example, administrators often grant broad permissions to help teams move fast when they get started. As teams and applications mature, their workloads only need a subset of permissions. However, customers may often fear removing permissions due to the risk of an operational impact caused by denying necessary access. Furthermore, customers may have difficulty determining when an existing allocated permission is not needed.

### BRIEF DESCRIPTION OF DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 is a diagram illustrating an example forecast-based permissions recommendation system that may be used in accordance with the present disclosure.

FIG. 2 is a diagram illustrating an example identity usage pattern that may be used in accordance with the present disclosure.

FIG. 3 is a diagram illustrating a first example interface display for showing identities with deallocation recommendations that may be used in accordance with the present disclosure.

FIG. 4 is a diagram illustrating a second example interface display for showing active deallocation recommendations for an identity that may be used in accordance with the present disclosure.

FIG. 5 is a diagram illustrating a third example interface display for showing for showing a deallocation recommendations history for an identity that may be used in accordance with the present disclosure.

FIG. 6 is a flowchart illustrating an example forecast-based permissions recommendation process that may be used in accordance with the present disclosure.

FIG. 7 is a diagram illustrating an example speculative execution-based permissions recommendation system that may be used in accordance with the present disclosure.

FIG. 8 is a diagram illustrating first example change condition indications that may be used in accordance with the present disclosure.

FIG. 9 is a diagram illustrating second example change condition indications that may be used in accordance with the present disclosure.

FIG. 10 is a diagram illustrating third example change condition indications that may be used in accordance with the present disclosure.

FIG. 11 is a diagram illustrating fourth example change condition indications that may be used in accordance with the present disclosure.

FIG. 12 is a flowchart illustrating an example speculative execution-based permissions recommendations process that may be used in accordance with the present disclosure.

FIG. 13 is a flowchart illustrating an example speculative execution-based permissions reevaluation process that may be used in accordance with the present disclosure.

FIG. 14 is a flowchart illustrating an example speculative execution-based model decision process that may be used in accordance with the present disclosure.

FIG. 15 is a flowchart illustrating an example speculative execution-based permissions reevaluation process that may be used in accordance with the present disclosure.

FIG. 16 is a diagram illustrating an example system for transmitting and providing data that may be used in accordance with the present disclosure.

FIG. 17 is a diagram illustrating an example computing system that may be used in accordance with the present disclosure.

### DETAILED DESCRIPTION

Techniques for forecast-based permissions recommendations are described herein. In some examples, a recommendations engine may periodically analyze an identity's allocated permissions and usage histories of those permissions. Based at least in part on the usage histories, the recommendations engine may make recommendations to a customer regarding which of the permissions should be retained and which of the permissions should be deallocated from the identity. The customer may then use these recommendations to potentially modify the identity's permissions, such as by deallocating one or more of the permissions that are recommended for deallocation. In order to make these recommendations, the recommendations engine may determine an extent to which an identity is likely to use a permission in the future. Generally, permissions that are determined to be more likely to be used in the future, such as above a selected probability threshold, may be recommended to be retained. By contrast, permissions that are determined to be less likely to be used in the future, such as below a selected probability threshold, may be recommended for deallocation.

In some conventional techniques, permissions may be kept or removed based on a determination of whether they have been used within a selected prior time window, such as within a previous 90 day time window. For example, permissions that have been used at least once within the previous 90 days may be retained. By contrast, permissions that have not been used within the previous 90 days may be removed. However, one problem with this technique is that it may result in removal of permissions that an identity is likely to use in the future. For example, consider a scenario in which an identity needs to use a given permission every 180 days, such as for the purposes of preparing reports. Now also consider the scenario in which the usage history for the identity indicates that the last time that the identity used this permission was 120 days ago. In this example, because the last usage date (120 days ago) is outside of the 90 day time window, a strict time-window based analysis would result in removal of the permission. However, because the identity needs to use the permission every 180 days, the identity will need to use this permission again in 60 days. Thus, even though the identity has not used the permission within the previous 90 day time window, removal of the permission is nevertheless not desirable.

In order to alleviate these and other problems, the techniques described herein may employ forecast-based permissions recommendations. Specifically, this may include analyzing permission usage information to determine an estimated probability that a permission will be used again in the future. In some examples, the estimated probability may be a percentage, a range of percentages, a relative weight (e.g., high, medium, low, etc.), or any other type of probability. In some cases, the estimated probabilities may be non-binary, meaning that permissions may be assigned more than only two possible probabilities (e.g., that permissions may be assigned probabilities other than only high probability or low probability). In some examples, permissions that have an estimated probability of future use that is greater than a threshold probability may be recommended to be retained. By contrast, permissions that have an estimated probability of future use that is less than a threshold probability may be recommended for deallocation.

The permission usage information that is analyzed to determine the estimated probabilities may include, for example, permissions usage history for the identity, permissions usage history for related identities (e.g., identities within the same customer account, global permissions usage history (e.g., for all identities in an identity management service), usage pattern data, and other recommendations information. In some examples, usage histories of related identities may assist in determining to retain a permission, even when the permission has not been used by a given identity. This is because related identities may often eventually use similar permissions. As a specific example, if an employee is frequently using a permission, then there may be a high likelihood that the employee's supervisor will eventually also use this same permission. Thus, in some examples, even when an identity has not used a permission, a recommendations engine may still recommend retaining of the permission if other related identities are frequently using the permission.

In some examples, the usage pattern data may be determined based at least in part on a machine learning analysis of the identity usage history, related identity usage history, and/or global usage history. The usage pattern data may include for example, patterns of repeat permission usage by an identity. For example, an identity's usage history may be analyzed to determine patterns associated with usage of a permission by the identity. As a specific example, if an identity uses a given permission every 180 days, then this may be determined and included in the identity usage pattern data. In some examples, even if an identity has not recently used a given permission (e.g., not within the previous 90 days), a recommendations engine may nevertheless estimate that the probability of future usage of the permission is high. For example, if the permission was previously used every 180 days, and it has been less than 180 days since the permission was last used, then the recommendations engine may determine that there is a high probability that the permission will be used again in the future (e.g., at the next 180 day interval). By contrast, if the permission was previously used every 180 days, but it has been more than 180 days since the permission was last used, then the recommendations engine may determine that there is a lower probability that the permission will be used again in the future (e.g., because the 180 day interval has expired).

The usage pattern data may also include patterns of permissions that are commonly used together. For example, machine learning components may analyze the global usage history to determine that Permission Y is frequently used in combination with Permission X. This may be helpful in determining when an identity is likely to, in the future, use a permission that the identity has not recently used (or may have never previously used). For example, consider a scenario in which an identity has frequently used Permission X but has not yet used Permission Y. In this example, even though the identity has not used Permission Y, a recommendations engine may look at the usage pattern data to determine that Permission Y is frequently used in combination with Permission X. Based on this information, the recommendations engine may estimate that there is a high probability that the identity will use Permission Y in the future, even though the identity has not yet done so.

In some examples, the permissions recommendations, such as to retain and/or deallocate one or more permissions, may be presented to a user via an interface. For example, in some cases, an interface may provide a display that includes a list of all identities for which one or more active permissions recommendations are made. In some cases, the display may indicate, for each identity, information such as a quantity of recommendations, a recommendation type (e.g., retain or deallocate), a time since one or more of the recommendations were initially made, and other information. Additionally, in some examples, a permission recommendation history display may be provided. In some cases, this display may indicate, for each permission, information such as a recommendation type (e.g., retain or deallocate), a policy granting the permission, a time since the recommendation was initially made, and other information.

An interface may also allow a user to select a given identity, and the interface may provide a display of each permission that is actively recommended for deallocation for the identity. In some cases, the display may indicate, for each permission that is actively recommended for deallocation, information such as a time at which the permission was last used, a region in which the permission was last used, a policy granting the permission, a time since the recommendation was initially made, and other information. This information may provide the user with a confirmation that the deallocation recommendation is valid and may also assist the user in determining whether, or not, to follow the recommendation and deallocate the permission. In some cases, the display may allow the user to select one or more of the permissions for deallocation and to deallocate the selected permissions. In some examples, a permission may be deallocated by modifying an existing policy that is attached to the identity and that includes the permission, such as to remove the permission from the policy. In other examples, a permission may be deallocated by detaching, from the identity, an existing policy that includes the permission. The detached policy may then optionally be replaced with a different policy that does not include the deallocated permission (but that does include other desired permissions).

In some examples, the permissions recommendations described herein may be made for deallocating permissions from an identity, for example as opposed to deleting and replacing the identity itself. For example, even when a permission is deallocated from an identity, the identity may remain active and persist with the retained permissions. This may be advantageous, for example, because it may allow permissions to be deallocated without causing the identity itself to be replaced/deleted. This may, for example, allow the existing identity to continue to interact with applications and resources for which the identity retains permissions, without requiring the customer to update/reconfigure those applications and resources.

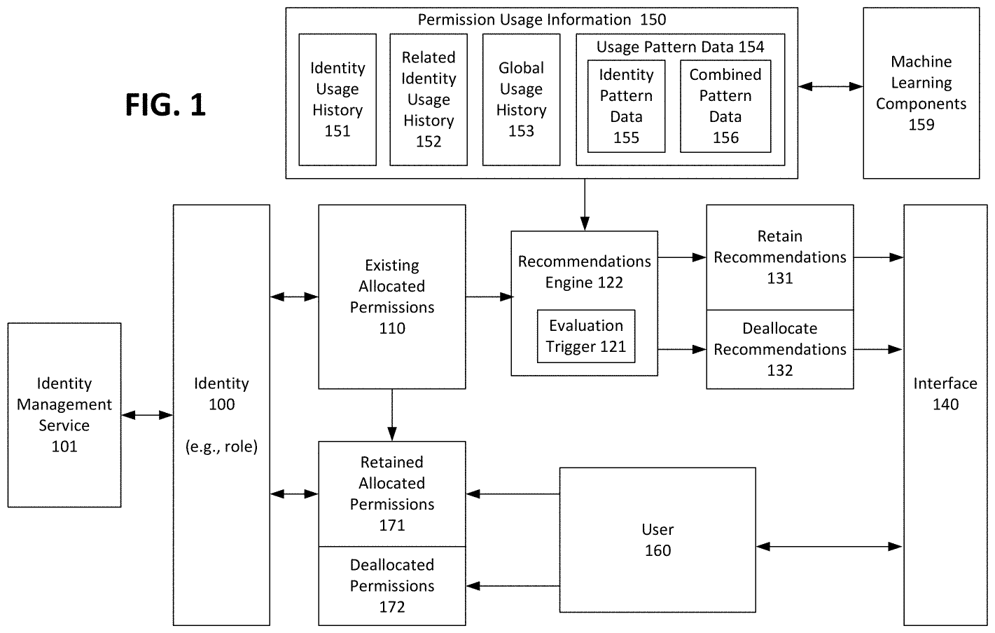

FIG. 1 is a diagram illustrating an example forecast-based permissions recommendation system that may be used in accordance with the present disclosure. As shown in FIG. 1, identity 100, such as a user, group, role, etc, may be managed using an identity management service 101. Identity management service 101 may allow a customer to create identity 100 and to allocate the existing allocated permissions 110 to the identity 100. In some examples, the existing allocated permissions 110 may be allocated to identity 100 by attaching one or more policies to identity 100. In some examples, a permission may include a service and/or resource and one or more actions that are permitted to be performed on the service and/or resource. Customers may often allocate more permissions than necessary to an identity. For example, administrators often grant broad permissions to help teams move fast when they get started. As teams and applications mature, their workloads only need a subset of permissions.

In the example of FIG. 1, a recommendations engine 122, such as may be provided by identity management service 101, may analyze the existing allocated permissions 110 to make retain recommendations 131 and deallocate recommendations 132. The deallocate recommendations 132 are recommendations to deallocate one or more of the existing allocated permissions from identity 100. By contrast, the retain recommendations 131 are recommendations to retain (i.e., not to deallocate from identity 100) one or more other of the existing allocated permissions 110. As described in greater detail, both the retain recommendations 131 and the deallocate recommendations 132 may be provided to a user 160, for example via an interface 140, which may also be provided by the identity management service 101.

In the example of FIG. 1, upon viewing the retain recommendations 131 and/or the deallocate recommendations 132, the user 160 chooses to deallocate, from identity 100, the permissions identified by the deallocate recommendations 132. Specifically, the user 160 may employ interface 140 to deallocate the deallocated permissions 172 from identity 100. The deallocated permissions 172 are the permissions identified by the deallocate recommendations 132. After being deallocated from the identity 100, the deallocated permissions 172 are no longer available to the identity 100 (unless and until they are optionally reallocated at a subsequent time). By contrast, the retained allocated permissions 171 are not deallocated from the identity 100. The retained allocated permissions 171 therefore remain allocated to the identity 100. In some examples, no user action is required to retain a permission in the retained allocated permissions 171. Rather, a permission may remain allocated to identity 100 unless the permission is deallocated by the user 160.

As shown in FIG. 1, the recommendations engine 122 may employ forecast-based techniques in order to perform permissions recommendations. Specifically, this may include analyzing permission usage information 150 to determine an estimated probability that a permission will be used again in the future. In some examples, the estimated probability may be a percentage, a range of percentages, a relative weight (e.g., high, medium, low, etc.), or any other type of probability. In some cases, the estimated probabilities may be non-binary, meaning that permissions may be assigned more than only two possible probabilities (e.g., that permissions may be assigned probabilities other than only high probability or low probability). In some examples, permissions that have an estimated probability of future use that is greater than a threshold probability may be recommended to be retained. By contrast, permissions that have an estimated probability of future use that is less than a threshold probability may be recommended for deallocation. The term forecast, as used herein, refers to a determination of an estimated probability of a future use. There is no requirement that a forecasted use must actually occur.

In the example of FIG. 1, the permission usage information 150 includes identity usage history 151, related identity usage history 152, global usage history 153, and usage pattern data 154. The identity usage history 151 may be a permissions usage history for identity 100. The related identity usage history 152 may be a permissions usage history for one or more identities that are related to identity 100, such as other identities within the same customer account as identity 100. Global usage history 153 may be a permission usage history for a broader range of identities, such as all identities that are managed by the identity management service 101. Data stored in the global usage history 153 (or other usage histories and/or usage patterns) may optionally be anonymized, for example such as not to reveal usage histories for given customers. It is noted that the identity usage history 151 and/or the related identity usage history 152 may be included in the global usage history 153. These usage histories are nevertheless displayed as separate elements in FIG. 1 because they may, in some examples, be separately aggregated and analyzed for recommendations purposes.

In some examples, the identity usage history 151 may provide a strong indication to retain or deallocate a permission. For example, if the identity usage history 151 indicates that a given permission has been both recently and frequently used by the identity 100, then this may be a strong indication to recommend retaining of the permission. Also, in some examples, the related identity usage history 152 may assist in determining to retain a permission, even when the permission has not been used by the identity 100. This is because related identities may often eventually use similar permissions. As a specific example, if an employee is frequently using a permission, then there may be a high likelihood that the employee's supervisor will eventually also use this same permission. Thus, in some examples, even when identity 100 has not used a permission, the recommendations engine 122 may still recommend retaining of the permission if other related identities are frequently using the permission.

In the example of FIG. 1, the usage pattern data 154 includes identity pattern data 155 and combined pattern data 156. In some examples, the usage pattern data 154 may be determined based at least in part on a machine learning analysis of the identity usage history 151, the related identity usage history 152, and/or the global usage history 153. This machine learning analysis may be performed by machine learning components 159. The identity pattern data 155 may include for example, patterns of repeat permission usage by identity 100. For example, the identity usage history 151 may be analyzed to determine patterns associated with usage of a permission by the identity 100. As a specific example, if identity 100 uses a given permission every 180 days, then this may be determined and included in the identity pattern data 155. In some examples, even if identity 100 has not recently used a given permission (e.g., not within the previous 90 days), a recommendations engine may nevertheless estimate that the probability of future usage of the permission is high.

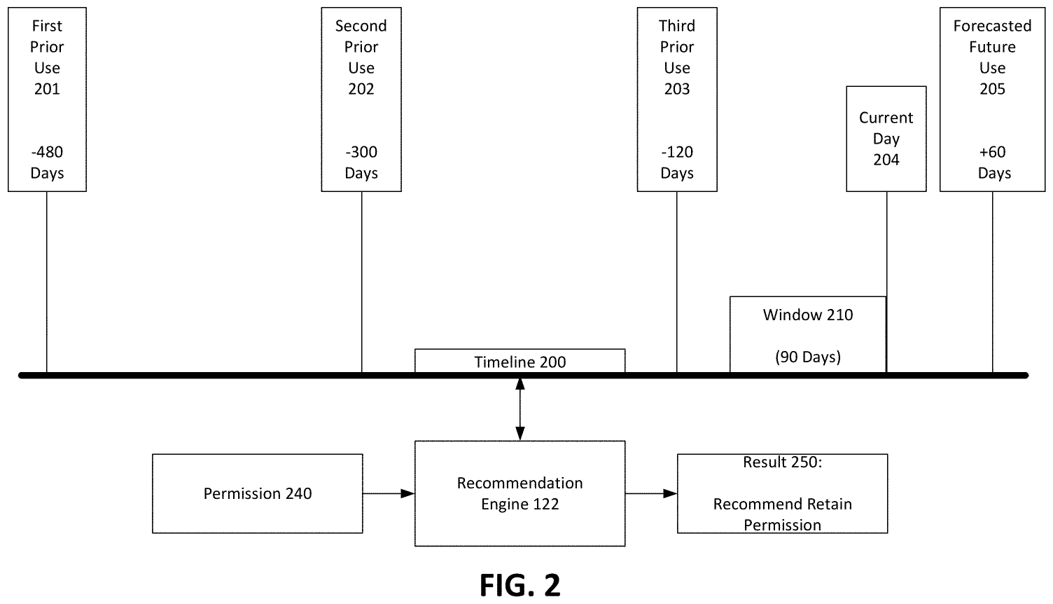

Referring now to FIG. 2, an example identity usage pattern will now be described in detail. In the example of FIG. 2, a timeline 200 is used to represent usage of a permission 240 by identity 100, for example based on identity usage history 151. Specifically, in this example, the identity usage history 151 indicates that a first prior use 201 of permission 240, by identity 100, occurred 480 days prior to a current day 204. Additionally, the identity usage history 151 indicates that a second prior use 202 of the permission 240, by identity 100, occurred 300 days prior to the current day 204. Furthermore, the identity usage history 151 indicates that a third prior use 203 of the permission 240, by identity 100, occurred 120 days prior to the current day 204. In this example, the gap between first prior use 201 and second prior use 202 is 180 days (i.e., the difference between 480 days and 300 days). Additionally, the gap between second prior use 202 and third prior use 203 is also 180 days (i.e., the difference between 300 days and 120 days). Based on this information, it may be determined that the identity 100 has used the permission 240 every 180 days. This usage pattern may be indicated in identity pattern data 155.

In the example of FIG. 1, window 210 is a sliding prior time window that the recommendations engine may determine to assist in the recommendations process. In this example, the window 210 has a duration of 90 days. It is appreciated, however, that other time durations may be used. In some examples, when a permission has been used within the window 210, then this may be an indication that the permission should be retained. In this example, however, the most recent prior usage of the permission 240 was third prior use 203, which was 120 days ago. Thus, the permission 240 has not been used at all within window 210. As will now be described in detail, although the permission 240 has not been used within window 210, the techniques described herein may be employed to determine that the permission 240 is nevertheless likely to be used again by identity 100 in the future. Specifically, in this case, by determining a usage pattern that indicates that the permission 240 has been used every 180 days, the techniques described herein may be employed to forecast that the permission 240 is likely to be used again at the next 180 day interval. In this example, the next 180 day interval falls 60 days in the future from the current date. Based on this usage pattern, a forecasted future use 205 of permission 240 is forecasted to occur 60 days from the current day 204. In this example, based on the forecasted future use 205, the recommendations engine 122 may determine to recommend retaining of the permission 240, as indicated by result 250.

Referring back to FIG. 1, it is seen that the usage pattern data 154 may also include combined pattern data 156, which may indicate patterns of permissions that are commonly used together. In some examples, combined pattern data 156 may be generated based on an analysis of global usage history 153 by machine learning components 159. As a specific example, machine learning components 159 may analyze global usage history 153 to determine that Permission Y is frequently used in combination with Permission X. This may be helpful in determining when an identity is likely to, in the future, use a permission that the identity has not recently used (or may have never used). For example, consider a scenario in which identity 100 has frequently used Permission X but has not yet used Permission Y. In this example, even though the identity 100 has not used Permission Y, the recommendations engine 122 may look at the combined pattern data 156 to determine that Permission Y is frequently used in combination with Permission X. Based on this information, the recommendations engine 122 may estimate that there is a high probability that the identity 100 will use Permission Y in the future, even though the identity 100 has not yet done so. In view of this, the recommendations engine 122 may recommend retaining of permission Y.

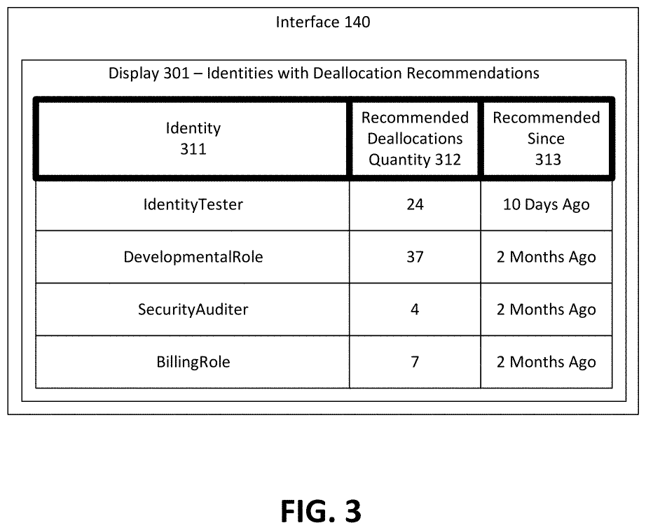

Referring back to FIG. 1, the permissions recommendations, such as retain recommendations 131 and/or deallocate recommendations 132, may be presented to user 160 via interface 140. Some examples of interface 140 will now be described in detail. Referring now to FIG. 3, an example is shown of a display 301 of a customer's identities with active deallocation recommendations. Active deallocations recommendations may include deallocation recommendations that have been made and that have not yet been accepted by the user (e.g., by deallocating those permissions from the identity) or removed (e.g., based on a reevaluation of the permissions). For example, a deallocation recommendation might be removed if an identity uses the permission several times after the deallocation recommendation is made. As shown, display 301, which is included in interface 140, includes an identity column 311, a recommended deallocations quantity column 312, and a recommended since column 313. The identity column 311 lists all of the customer's identities with active deallocation recommendations In some examples, additional identities (and their respective information) may be shown in display 301 by scrolling up or down. The recommended deallocations quantity column 312 indicates a quantity of active deallocation recommendations for each identity listed in identity column 311. The recommended since column 313 indicates an amount of time since the recommendations were made, such as an amount of time since an oldest active deallocate recommendation was made for an identity, an amount of time since a most recent active deallocate recommendation was made for an identity, or an average amount of time since all of the active deallocate recommendations were made for an identity.

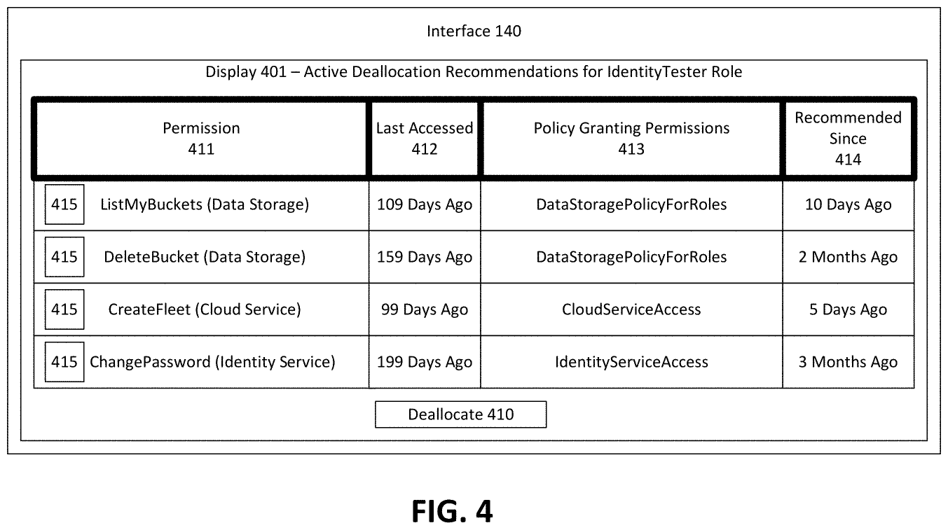

In some examples, a user may select one of the identities listed in identity column 311, such as to view more detailed recommendations information. For example, in some cases, a user may select one of the identities in identity column 311, such as by clicking on the identity's name (and/or its corresponding row in display 301) using a mouse, touchscreen, etc. Referring now to FIG. 4, an example is shown of a display 401 of active deallocate recommendations for a selected identity (i.e., the IdentityTester role). For example, in some cases, display 401 may be presented in response to a user selecting the IdentityTester role from via display 301, such as by clicking on the IdentityTester name in identity column 311. As shown in FIG. 4, display 401 includes a permission column 411, a last accessed column 412, a policy granting permissions column 413, and a recommended since column 414. The permission column 411 lists each permission of the IdentityTester role for which an active deallocation recommendation has been made. In some examples, additional permissions (and their respective information) may be shown in display 401 by scrolling up or down. The last accessed column 412 indicates an amount of time that has expired since a most recent time that each permission listed in permissions column 411 was used by the IdentityTester role. This information may provide the user with a confirmation that the deallocation recommendation is valid and may also assist the user in determining whether, or not, to follow the recommendation and deallocate the permission. In some examples, in addition, or as alternative to, a last accessed time, other last access information may be displayed, such as a region in which the permission was last accessed/used by the IdentityTester role. The policy granting permissions column 413 indicates a policy that grants each permission listed in permission column 411. The recommended since column 414 indicates an amount of time since each respective deallocate recommendation was initially made.

In the example of FIG. 4, the display 401 includes checkboxes 415 that allow the user to select one or more of the permissions listed in permissions column 411, such as by clicking on the checkboxes 415 using a mouse, touchscreen, etc. Additionally, in the example of FIG. 4, the user may select deallocate button 410, for example to trigger an initiation of a deallocation process for each selected permission. In some examples, a permission may be deallocated by modifying an existing policy that is attached to the identity and that includes the permission, such as to remove the permission from the policy. In other examples, a permission may be deallocated by detaching, from the identity, an existing policy that includes the permission. The detached policy may then optionally be replaced with a different policy that does not include the deallocated permission (but that does include other desired permissions). In some examples, the permissions recommendations described herein may be made for deallocating permissions from an identity, for example as opposed to deleting and replacing the identity itself. For example, even when a permission is deallocated from the IdentityTester role, the IdentityTester role may remain active and persist with the retained permissions. This may be advantageous, for example, because it may allow permissions to be deallocated without causing the IdentityTester role itself to be deleted and/or replaced. This may, for example, allow the IdentityTester role to continue to interact with applications and resources for which the IdentityTester role retains permissions, without requiring the customer to update/reconfigure those applications and resources.

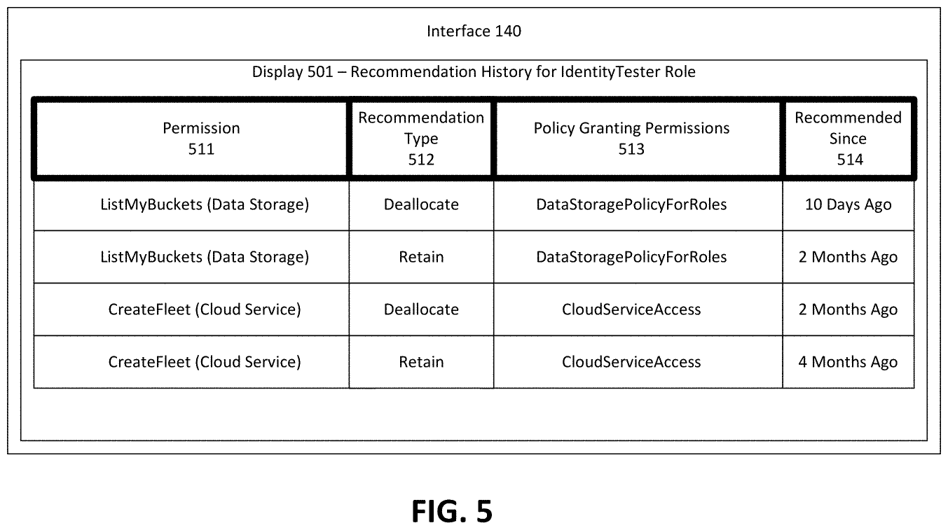

In some examples, in addition to active recommendations, interface 140 may also provide a recommendations history, for example showing both active recommendations and previous recommendations that are no longer active. Referring now to FIG. 5, an example is shown of a display 501 of a recommendation history for a selected identity (i.e., the IdentityTester role). As shown in FIG. 4, display 501 includes a permission column 511, a recommendation type column 512, a policy granting permissions column 513, and a recommended since column 514. The permission column 511 lists each permission of the IdentityTester role for which a recommendation has been made (whether still active or no longer active). The recommendation type column 512 indicates a recommendation type (e.g., retain or deallocate) for each listed recommendation. The policy granting permissions column 513 indicates a policy that grants each permission listed in permission column 411. The recommended since column 414 indicates an amount of time since each respective recommendation was initially made. For example, the display 501 includes two rows corresponding to the ListMyBuckets (Data Storage) permission. The lower of these two rows indicates that, two months ago, a recommendation was to retain the ListMyBuckets (Data Storage) permission. However, the next row up indicates that, ten days ago, the retain recommendation for ListMyBuckets (Data Storage) permission was changed to a deallocate recommendation. For example, ten days ago, the recommendations engine may have reevaluated the permissions for the IdentityTester role and determined that the ListMyBuckets (Data Storage) permission was no longer likely to be used in the future by the IdentityTester role, thereby causing the recommendations engine to change the recommendation for the ListMyBuckets (Data Storage) permission from retain to deallocate. It is noted that any, or all, of displays 301, 401, and 501 may be displayed via a user interface, such as a graphical user interface (GUI) of a computer, for example via a computer display screen or monitor.

In some examples, permissions recommendations may be reevaluated at fixed repeating intervals, such as every week, every ten days, etc. In other examples, permissions recommendations may be reevaluated in response to an event, such as a change in usage behavior by the identity. This change in usage behavior may include, for example, accessing of a new service and/or resource for the first time, failure to re-access a service and/or resource at an expected time, and/or other changes in behavior. In some examples, an identity's usage may be monitored to determine when an event occurs that may trigger reevaluation of recommendations. For example, when a user accesses a new service and/or resource for the first time, this may trigger permissions recommendations to be reevaluated, such as because it could cause a deallocation recommendation associated with permissions for the service and/or resource to be changed to a retain recommendation. As yet another example, a failure to re-access a service and/or resource at an expected time may also cause permissions recommendations to be reevaluated. For example, referring back to FIG. 2, if the identity 100 failed to use permission 240 on the day of the forecasted future use 205, then this may cause the recommendation for permission 240 to be changed from a retain recommendation to a deallocate recommendation. In some examples, on the current day 204, identity management service 101 may schedule a task to review usage of permission 240 on the day of the forecasted future use 205 (or on a date determined based on the forecasted future use 205) to determine whether permission 240 is used as predicted. Referring back to FIG. 1, it is shown that the recommendations engine 122 includes an evaluation trigger 121, which causes the recommendations engine to evaluate (or reevaluate) the permissions for identity 100. The evaluation trigger 121 may be a change in behavior, a fixed reevaluation interval (e.g., every week, every ten days, etc.), or any other trigger that causes evaluation (or reevaluation) of the permissions for identity 100.

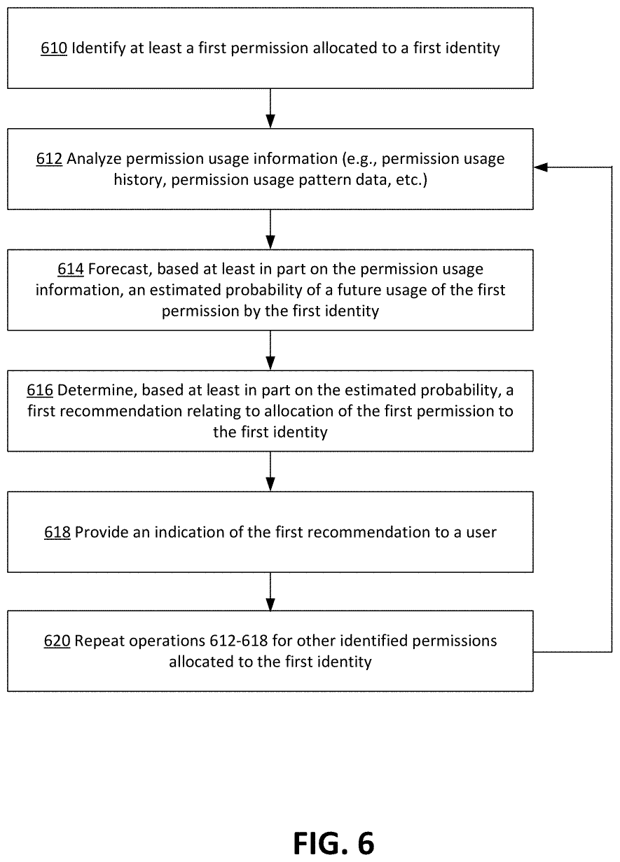

FIG. 6 is a flowchart illustrating an example forecast-based permissions recommendation process that may be used in accordance with the present disclosure. The process of FIG. 6 is initiated at operation 610, at which at least a first permission allocated to a first identity is identified. The first identity may be managed by an identity management service. As shown in FIG. 1, existing allocated permissions 110, for example including the first permission, may be allocated to an identity 100. In some examples, an identity management service may maintain one or more stored records that indicate which permissions are allocated to the first identity. Additionally, in some examples, the first permission (and other permissions allocated to the first identity) may be identified by analyzing these one or more stored records.

At operation 612, permission usage information is analyzed. As described above, the permission usage information may include, for example, a permission usage history of the first identity (e.g., identity usage history 151), a permission usage history of one or more other identities that are related to the first identity (e.g., related identity usage history 152), and a global permission usage history, such as for all identities managed by the identity management service (e.g., global usage history 153). The permission usage information may also include, for example, permission usage pattern data (e.g., usage pattern data 154). The permission usage pattern data may include, for example, identity pattern data and combined pattern data. The identity pattern data may include for example, patterns of repeat permission usage by the first identity. The combined pattern data may indicate patterns of permissions that are commonly used together. In some examples, the permission usage pattern data may be determined based at least in part on a machine learning analysis of usage histories of a plurality of identities. For example, in some cases, the combined pattern data may be determined based at least in part on a machine learning analysis of the global permission usage history. In some examples, the permission usage data may be analyzed by any combination of the recommendations engine 122, the machine learning components 159, and/or other components. As described in detail above, in some examples, the permission usage information may be analyzed to determine information regarding prior usages of the first permission by the first identity, prior usages of the first permission by related identities, usage patterns relating to the first permission (e.g., repeat usage of the first permission, frequent usage of the first permission in combination with other permissions, etc.) by the first identity, related identities and/or on a global scale, and many other types information.

At operation 614, an estimated probability of a future usage of the first permission by the first identity is forecasted based, at least in part, on the permission usage information. In one specific example, the identity usage history 151 may be looked at first, such as to determine whether the first identity has recently used the first permission. For example, in some cases, it may be determined if the first identity has used the first permission within a sliding time window extending back from the current time/day, such as within a most recent 90 days. In some examples, if the first identity has used the first permission within this sliding time window, then there may be a high estimated probability of future use. Additionally, if the first permission has been used more than once (or several times) within this sliding time window, then this may cause the estimated probability to be higher than if the first permission was used only once (or only a small number of times). By contrast, if the first permission has not been used within the sliding time window, then the recommendations engine may examine other factors. For example, the recommendations engine may examine the related identity usage history 152 to determine whether the first permission has been used by other identities that are related to the first identity (e.g., identities within the same customer account). If the first permission has been used by one or more other related identities within the sliding time window, then this may also cause the estimated probability to be high. Additionally, in some examples, the recommendations engine may examine the identity pattern data to determine whether the first identity has established a pattern of usage of the first permission at repeat intervals (e.g., as shown in FIG. 2). In some examples, if the first identity has established such a repeat pattern of use, then this may also cause the estimated probability to be high. In some cases, the estimated probability may be higher when the first identity has established this pattern and followed it consistently, while the estimated probability may be less high when the usage pattern has been interrupted or stopped altogether. Furthermore, in some examples, the recommendations engine may examine the identity usage history to determine other permissions that have been recently used by the first identity. The recommendations engine may then examine the combined pattern data to determine whether any of these other recently used permissions are frequently used in combination with the first permission. In some examples, if one or more of these other recently used permissions are frequently used in combination with the first permission, then this may also cause the estimated probability to be high. By contrast, in some examples, if the first permission has not been recently used by the first identity, and if the usage pattern data fails to indicate that the first permission is likely to be used in the future, then the estimated probability of future use may be determined to be low. In some examples, the estimated probability may be expressed using at least one of a percentage or a ratio. It is noted, however, that the estimated probability may also be expressed in other ways, such as using a relative weight (e.g., high, medium, low, etc.) or other techniques.

At operation 616, a first recommendation relating to allocation of the first permission to the first identity is determined, based at least in part on, the estimated probability. In some examples, the first recommendation may be a recommendation for the first identity to retain the first permission or a recommendation to deallocate the first permission from the first identity. For example, in some cases, the recommendations engine may compare the estimated probability to a threshold probability, such as a threshold probability selected by the identity management service and/or by a customer. In some examples, it may be determined that the estimated probability is less than the threshold probability. It may then be determined to recommend deallocation of the first permission based, at least in part on, the estimated probability being less than the threshold probability. In some other examples, it may be determined that the estimated probability is greater the threshold probability. It may then be determined to recommend retaining of the first permission based, at least in part, on the estimated probability being greater than the threshold probability. In some examples, the threshold probability may be expressed using at least one of a percentage or a ratio. It is noted, however, that the threshold probability may be expressed in other ways, such as using other using weights or other techniques. In one specific example, a pattern of repeat usage of the first permission by the first identity may be determined (e.g., every 180 days, as shown in FIG. 2). It may then be determined, based at least in part on the pattern of repeat usage, to recommend retaining of the first permission by the first identity (e.g., as shown in result 250 of FIG. 2). In another specific example, it may be determined that a second identity, which is related to the first identity, has used the first permission. It may then be determined, based at least in part on usage of the first permission by the second identity, to recommend retaining of the first permission by the first identity.

At operation 618, an indication of the first recommendation is provided to a user. For example, in some cases, the indication of the first recommendation may be provided via an interface of the identity management service. As a specific example, FIG. 4 shows a display 401 that presents active deallocation recommendations for a selected identity (i.e., the Identity Tester role). As another example, FIG. 5 shows a display 401 that presents a recommendations history for the Identity Tester role, including a history of deallocation recommendations and retain recommendations. An interface may also display last access information associated with a last access of the first permission by the first identity.

At operation 620, a repetition is performed of prior operations 612-618 for one or more other identified permissions allocated to the first identity. For example, for a second permission, the permission usage information may optionally be re-analyzed in relation to the second permission, an estimated probability of a future usage of the second permission by the first identity may be forecasted based, at least in part, on the permission usage information. A second recommendation (e.g., to retain or deallocate the second permission) may then be determined, based at least in part on, the estimated probability. An indication of the second recommendation may then be provided to the user.

In some examples, after making recommendations for the permissions that are allocated to the first identity, the identity management service may review the recommendations to determine whether a collective recommendation should be made for the identity as whole. For example, in some cases, if the service has recommended that all (or a large percentage) of the permissions should be deallocated, then this may indicate that the first identity may no longer be necessary. Thus, in some examples, such as when an amount (e.g., quantity, percentage, etc.) of deallocation recommendations for an identity exceeds a selected threshold, the service may make an additional recommendation that the identity itself should be deleted (or that the customer should at least consider whether the identity is still useful and/or necessary). For example, in some cases, this may occur when the quantity of deallocation recommendations for the identity exceeds a threshold quantity and/or when the percentage of threshold recommendations (e.g., as compared to the total quantity of permissions allocated to the identity as a whole) exceeds a threshold percentage.

As described above, the evaluation of the permissions recommendations may be performed based on a trigger, such as a change in behavior of the first identity. For example, a change in usage behavior by the first identity may be detected. It may then be determined, based at least in part on the change in the usage behavior, to evaluate (including an initial evaluation and/or a reevaluation) permissions recommendations for the first identity. In some examples, the change in behavior may include accessing, by the first identity, of a service that the first identity has not previously accessed. In other examples, the change in behavior may include failing to use a permission at a repeating time interval.

In some examples, permissions may be analyzed in association with various access constructs, such as in relation to public access. For example, in some cases, usage of computing services, resources, and the like may be monitored to determine permissions recommendations. As a specific example, suppose that a given computing resource is currently publicly accessible. Now suppose that an analysis of the resource's usage indicates that it is only being used by a single account. In this example, because the resource is only being used by a single account, it may be determined that public access to the resource is unnecessary. In this scenario, a recommendation may be made to remove public access to the resource, and limit access to resource to the single account that is actually using the resource.

Techniques for model decisions, such as permissions recommendations, based on speculative execution are also described herein. As described above, various techniques may be employed to assist in providing recommendations to users regarding existing allocated permissions. These recommendations may include recommendations to retain one or more of the existing allocated permissions and recommendations to deallocate one or more other of the existing allocated permissions. As also described above, machine learning techniques may be employed to assist in identifying various usage patterns and making recommendations based at least in part on these usage patterns.

According to techniques described herein, permissions recommendations may be made based at least in part on speculative execution of a machine learning model. A speculative execution, as that term is used herein, refers to an evaluation that is made (e.g., made by a machine learning model) based on a condition that has not actually occurred (i.e., that is merely theoretical) at the time that the evaluation is made. A speculative execution may be performed based on either a past condition or a future condition. When a speculative execution is performed based on a past condition, the past condition may be attributed to an identity, even though the past condition did not actually occur in fact. For example, a past condition may be a condition in which an identity is considered to have accessed a service during a prior time period, even though the identity did not actually access the service during the prior time period. When a speculative execution is performed based on a future condition, the future condition may be attributed to an identity, even though the future condition has not actually occurred in fact. For example, a future condition may be a condition in which an identity is considered to access a service during a future time period, even though the identity may, or may not, eventually actually access the service during the future time period.

As described below, speculative executions of machine learning models may make permissions recommendations more explainable, thereby building customer trust. Earning and maintaining customer trust may be important to the success of permissions recommendations because it is ultimately up to the customer to follow or ignore the recommendations. For example, some customers may be concerned that a recommendations engine could recommend too many deallocations, thereby causing accessibility problems. Some customers may also be concerned that a recommendations engine could recommend too many retains, thereby causing potential security problems. To alleviate these and other problems, speculative execution may be employed to assist in providing robust explanations of permissions recommendations.

In some cases, when a recommendation is made, speculative execution of a machine learning model may be performed to determine one or more conditions that would result in changing the recommendation. These may include, for example, conditions in which the identity accesses (or does not access) a given service within a given time period. For example, when a deallocate recommendation is made, speculative execution may be employed to determine one or more conditions that may cause the deallocate recommendation to change to a retain recommendation. Indications of these conditions may then be provided to a user. Specifically, a past condition may be determined that, if it had actually occurred, would have caused the deallocate recommendation to change to a retain recommendation. For example, the user may be informed that, if an identity had accessed a given service within the past 15 days, that a deallocate recommendation for the identity would be changed to a retain recommendation. As another example, the user may be informed that, if an identity had not accessed another given service within the past 15 days, that the deallocate recommendation for the identity would be changed to a retain recommendation. Additionally, a future condition may be determined that, if performed, will cause the deallocate recommendation to change to a retain recommendation. For example, the user may be informed that, if the identity accesses a given service within the next 15 days, that the deallocate recommendation for the identity will be changed to a retain recommendation. As another example, the user may be informed that, if the identity does not access another given service within the next 15 days, that the deallocate recommendation for the identity will be changed to a retain recommendation.

As another example, when a retain recommendation is made, speculative execution may be employed to determine one or more conditions that may cause the retain recommendation to change to a deallocate recommendation. Indications of these conditions may then be provided to a user. Specifically, a past condition may be determined that, if it had actually occurred, would have caused the retain recommendation to change to a deallocate recommendation. For example, the user may be informed that, if an identity had accessed a given service within the past 15 days, that a retain recommendation for the identity would be changed to a deallocate recommendation. As another example, the user may be informed that, if an identity had not accessed another given service within the past 15 days, that the retain recommendation for the identity would be changed to a deallocate recommendation. Additionally, a future condition may be determined that, if performed, will cause the retain recommendation to change to a deallocate recommendation. For example, the user may be informed that, if the identity accesses a given service within the next 15 days, that the retain recommendation for the identity will be changed to a deallocate recommendation. As another example, the user may be informed that, if the identity does not access another given service within the next 15 days, that the retain recommendation for the identity will be changed to a deallocate recommendation.

By making the user aware of these conditions, the user may be given greater insight into how a machine learning model works and given greater awareness of how and why recommendations may sometimes change over time. This may build customer trust, which may make the customers more likely to accept the recommendations. Some conventional techniques for explaining machine learning models may provide explanations of how actual past events have influenced a decision that is made by a model. However, techniques which are based strictly on actual events may fall short because they cannot inform users about actions that could have been taken (or not taken) in the past and that would have changed a recommendation. Moreover, techniques which are based strictly on actual events may also fall short because they cannot inform users about actions that can be taken (or not taken) in the future and that will change a recommendation.

In addition to making recommendations more explainable, the techniques described herein may also make recommendations more consistent and reliable. For example, consider a scenario in which a machine learning model has consistently recommended that an identity should retain a permission for accessing a service named PPService. Now suppose that the identity performs a single access of a service named MMService. In this example, MMService is a member of a genre of services that the identity has not used before and will not be using again. In some examples, the identity's accessing of MMService may cause a machine learning model to change the recommendation for PPService, which has consistently been a retain recommendation in the past, to a deallocate recommendation. However, this may be a poor recommendation because the identity has only accessed MMService once, and the single accessing of MMService should not cause the permission for PPService to be deallocated. In some examples, speculative execution of the machine learning model may reveal that, if the identity had not performed the single access of MMService, the recommendation for PPService would have stayed as a retain recommendation and would not be changed to deallocate. Based on this information, it may be determined that the machine learning model should not recommend deallocation of PPService and should continue to recommend retaining PPService. In this and other scenarios, speculative execution may prevent machine learning models from making inconsistent recommendations, thereby improving the consistency and reliability of the models.

Furthermore, the techniques described herein may also be used to improve efficiency of the recommendations process. For example, one simple approach that could be employed is to have the machine learning model reevaluate recommendations at fixed time periods (e.g., once a day, once a week etc.). However, this is inefficient because the model's recommendations may often stay the same. In some examples, speculative execution may identify future conditions that would cause the identity's recommendations to change. Instead of reevaluating an identity's recommendations at fixed time periods, the machine learning model may instead be configured to only reevaluate an identity's recommendations when the one of the determined future conditions occur that would cause a recommendation to be changed. Similarly, speculative execution may identify future conditions that would not cause the identity's recommendations to change. The machine learning model may then be configured to not reevaluate the identity's recommendations when these conditions occur (and to instead reevaluate the identity's recommendations based on occurrences of other conditions, such as those that will cause the model to change). Enabling selective decision updating is one way in which speculative execution may also be employed for improving the efficiency of temporal machine learning models.

While the above examples relate to permissions recommendations, it is noted that the speculative execution based techniques described herein may be employed to other scenarios in which machine learning models are employed to make decisions regarding an entity. For example, while permissions recommendations are one type of decision, machine learning models may be employed to make many other types of decisions, such as decisions regarding fraud detection, retail and other sales forecasting, price fluctuations for stocks and other assets, recommendations of new products and features for customers, and the like. Thus, while an identity is one type of entity for which a machine learning model may make decisions, machine learning models may also make decisions for other entities such as financial entities, customers, companies, products and the like. For example, a machine learning model may make a first decision relating to an entity. A first indication of the first decision may be provided to one or more users. The machine learning model may employ speculative execution to detect a first condition that, when attributed to the entity, causes changing of the first decision to a second decision, wherein the second decision differs from the first decision. A second indication may then be provided, to the one or more users, that attribution of the first condition to the entity causes the changing of the first decision to the second decision. For example, for video streaming services, machine learning models may be employed to make decisions regarding new videos that a customer might like to view. When a model recommends a new video to a customer, the techniques described herein may be employed to provide the customer with information about other types of videos that the customer could have viewed in the past, or could view in the future, that would change the model's decision and cause the model to recommend a different type of video to the customer.

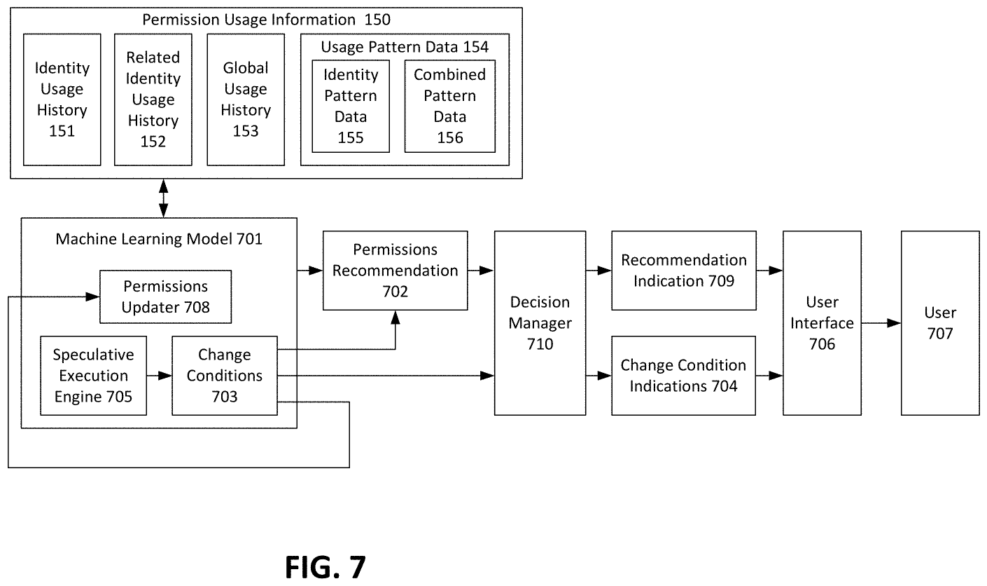

FIG. 7 is a diagram illustrating an example speculative execution-based permissions recommendation system that may be used in accordance with the present disclosure. As shown in FIG. 7, machine learning model 701 makes a permissions recommendation 702 based at least in part on permission usage information 150. The permissions recommendation 702 is provided to decision manager 710. Decision manager 710, in turn, generates recommendation indication 709, which is an indication of the permissions recommendation 702. Recommendation indication 709 is provided to user 707, such as by being displayed in a user interface 706. In some examples, machine learning model 701 may include machine learning components 159 and recommendations engine 122 of FIG. 1. Various example machine learning-based techniques for making permissions recommendations based on permission usage information 150 are described in detail above with reference to FIGS. 1-6, and these example techniques are not repeated here. Any, or all, of these example techniques may be employed by machine learning model 701 to make permissions recommendation 702. In some examples, permissions recommendation 702 may be a recommendation to deallocate a permission that is currently allocated to an identity. In other examples, permissions recommendation 702 may be a recommendation to retain a permission that is currently allocated to an identity.

As shown in FIG. 7, machine learning model 701 includes a speculative execution engine 705. The speculative execution engine may employ speculative execution of the machine learning model 701 to determine change conditions 703. The change conditions 703 are theoretical conditions that would cause the permissions recommendation 702 to change to a different (alternative) recommendation. In order to determine the change conditions 703, the speculative execution engine 705 may evaluate several theoretical conditions using the methodology of machine learning model 701. In some examples, the speculative execution engine 705 may employ techniques such as adversarial example generation techniques and synthetic data generation techniques. For example, in some cases, adversarial example generation techniques may be employed, such as to assist in determining types of theoretical conditions that will cause the permissions recommendation 702 to change. Moreover, in some examples, synthetic data generation techniques may be employed, such as to assist in determining realistic example scenarios of change conditions 703 that may be explained/indicated to the user 707. If a given theoretical condition causes the permissions recommendation 702 to change, then the given theoretical condition is included in the change conditions 703. By contrast, if the given theoretical condition does not cause the permissions recommendation 702 to change, then the given theoretical condition is not included in the change conditions 703. The theoretical conditions that are evaluated may include past theoretical conditions (e.g., conditions that could have occurred in the past but which did not actually occur) as well as future theoretical conditions (e.g., conditions that could occur in the future but which may, or may not, actually occur).

If the permissions recommendation 702 is a deallocate recommendation, then the change conditions 703 may include one or more conditions that may cause the deallocate recommendation to change to a retain recommendation. Specifically, a past condition may be determined that, if it had actually occurred, would have caused the deallocate recommendation to change to a retain recommendation. One such condition could be that, if an identity had accessed a given service within the past 15 days, then the deallocate recommendation for the identity would be changed to a retain recommendation. Another such condition could be that, if an identity had not accessed another given service within the past 15 days, that the deallocate recommendation for the identity would be changed to a retain recommendation. Additionally, a future condition may be determined that, if performed, will cause the deallocate recommendation to change to a retain recommendation. One such condition could be that, if the identity accesses a given service within the next 15 days, that the deallocate recommendation for the identity will be changed to a retain recommendation. Another such condition could be that, if the identity does not access another given service within the next 15 days, that the deallocate recommendation for the identity will be changed to a retain recommendation.

By contrast, if the permissions recommendation 702 is a retain recommendation, then the change conditions 703 may include one or more conditions that may cause the retain recommendation to change to a deallocate recommendation. Specifically, a past condition may be determined that, if it had actually occurred, would have caused the retain recommendation to change to a deallocate recommendation. One such condition could be that, if an identity had accessed a given service within the past 15 days, that a retain recommendation for the identity would be changed to a deallocate recommendation. Another such condition could be that, if an identity had not accessed another given service within the past 15 days, that the retain recommendation for the identity would be changed to a deallocate recommendation. Additionally, a future condition may be determined that, if performed, will cause the retain recommendation to change to a deallocate recommendation. One such condition could be that, if the identity accesses a given service within the next 15 days, that the retain recommendation for the identity will be changed to a deallocate recommendation. Another such condition could be that, if the identity does not access another given service within the next 15 days, that the retain recommendation for the identity will be changed to a deallocate recommendation.

In the example of FIG. 7, change conditions 703 are provided to decision manager 710. Decision manager 710, in turn, generates change condition indications 704 based on change conditions 703. The change condition indications 704 are indications of one or more of the change conditions 703. The change condition indications 704 are provided to the user 707, such as by being displayed in the user interface 706. By making the user aware of the change conditions 703, the user may be given greater insight into how machine learning model 701 works and given greater awareness of how and why recommendations may sometimes change over time. This may build customer trust, which may make the customers more likely to accept the recommendations.

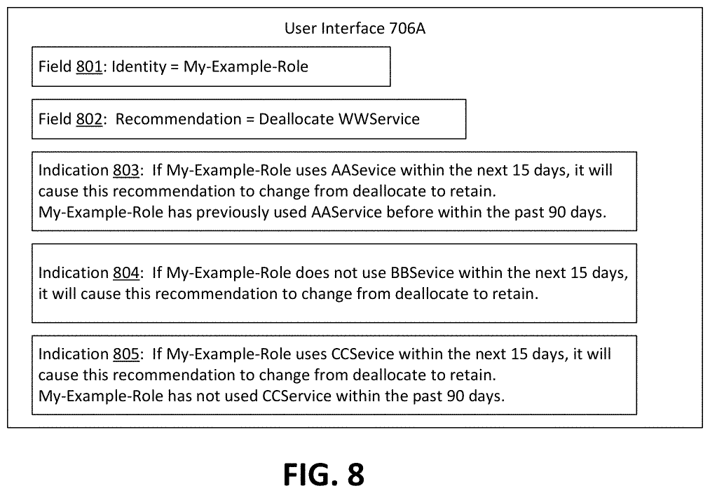

Some examples of the change condition indications 704 will now be described in detail with reference to FIGS. 8-11. Referring now to FIG. 8, user interface 706A is shown. User interface 706A is one example of user interface 706 of FIG. 7. As shown, user interface 706A includes field 801, which indicates that a recommendation is made for an identity named My-Example-Role. User interface 706A also includes field 802, which indicates that a recommendation is made to deallocate permissions for WWService from the My-Example-Role identity. User interface 706A includes indications 803-805, which are examples of change condition indications 704. Specifically, indications 803-805 are indications of future conditions that would cause the recommendation to deallocate WWService to change to a recommendation to retain WWService. In particular, indication 803 specifies that if My-Example-Role uses AASevice within the next 15 days, it will cause the recommendation to change from deallocate to retain. Indication 803 also specifies that My-Example-Role has previously used AAService before within the past 90 days. Indication 804 specifies that, if My-Example-Role does not use BBSevice within the next 15 days, it will cause the recommendation to change from deallocate to retain. Indication 805 specifies that, if My-Example-Role uses CCSevice within the next 15 days, it will cause the recommendation to change from deallocate to retain. Indication 805 further specifies that My-Example-Role has not used CCService within the past 90 days.

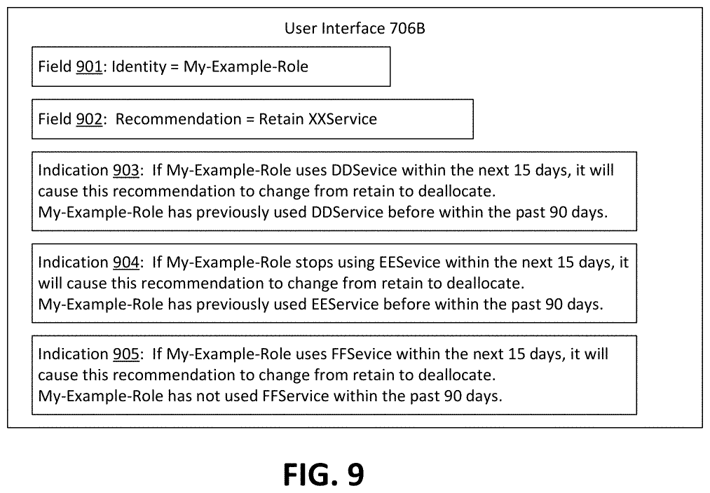

Referring now to FIG. 9, user interface 706B is shown. User interface 706B is another example of user interface 706 of FIG. 7. As shown, user interface 706B includes field 901, which indicates that a recommendation is made for an identity named My-Example-Role. User interface 706B also includes field 902, which indicates that a recommendation is made to retain permissions for XXervice for the My-Example-Role identity. User interface 706B includes indications 903-905, which are examples of change condition indications 704. Specifically, indications 903-905 are indications of future conditions that would cause the recommendation to retain XXService to change to a recommendation to deallocate XXService. In particular, indication 903 specifies that if My-Example-Role uses DDSevice within the next 15 days, it will cause the recommendation to change from retain to deallocate. Indication 903 also specifies that My-Example-Role has previously used DDService before within the past 90 days. Indication 904 specifies that, if My-Example-Role does not use EESevice within the next 15 days, it will cause the recommendation to change from retain to deallocate. Indication 905 specifies that, if My-Example-Role uses FFSevice within the next 15 days, it will cause the recommendation to change from retain to deallocate. Indication 905 further specifies that My-Example-Role has not used FFService within the past 90 days.

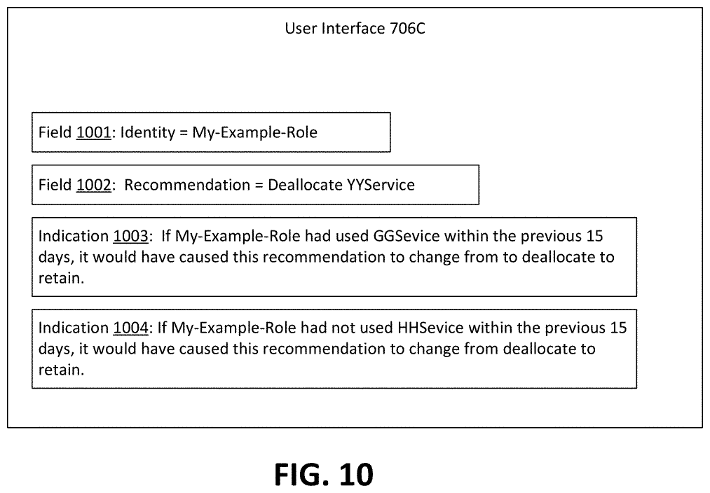

Referring now to FIG. 10, user interface 706C is shown. User interface 706C is another example of user interface 706 of FIG. 7. As shown, user interface 706C includes field 1001, which indicates that a recommendation is made for an identity named My-Example-Role. User interface 706C also includes field 1002, which indicates that a recommendation is made to deallocate permissions for YYService from the My-Example-Role identity. User interface 706C includes indications 1003-1004, which are examples of change condition indications 704. Specifically, indications 1003-1004 are indications of past conditions that would cause the recommendation to deallocate YYService to change to a recommendation to retain YYService. In particular, indication 1003 specifies that, if My-Example-Role had used GGSevice within the previous 15 days, it would have caused the recommendation to change from to deallocate to retain. Indication 1004 specifies that, if My-Example-Role had not used HHSevice within the previous 15 days, it would have caused the recommendation to change from deallocate to retain.

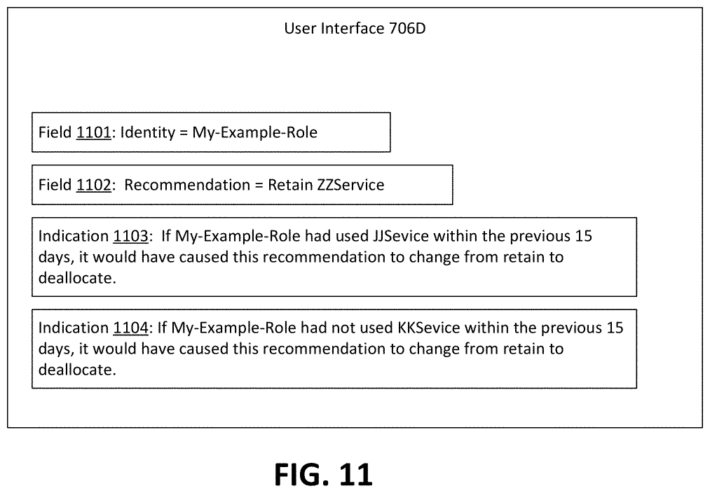

Referring now to FIG. 11, user interface 706D is shown. User interface 706D is another example of user interface 706 of FIG. 7. As shown, user interface 706D includes field 1101, which indicates that a recommendation is made for an identity named My-Example-Role. User interface 706D also includes field 1102, which indicates that a recommendation is made to retain permissions for ZZervice for the My-Example-Role identity. User interface 706D includes indications 1103-1104, which are examples of change condition indications 704. Specifically, indications 1103-1104 are indications of past conditions that would cause the recommendation to retain ZZService to change to a recommendation to deallocate ZZService. In particular, indication 1103 specifies that, if My-Example-Role had used JJSevice within the previous 15 days, it would have caused the recommendation to change from retain to deallocate. Indication 1104 specifies that, if My-Example-Role had not used KKSevice within the previous 15 days, it would have caused the recommendation to change from retain to deallocate.

Thus, as described above, change condition indications 704 may be provided to a user 707, such as to make a permissions recommendation 702 more explainable to the user 707. The speculative execution techniques described herein may also make recommendations more consistent and reliable. For example, consider a scenario in which machine learning model 701 has consistently recommended that an identity should retain a permission for accessing a service named PPService. Now suppose that the identity performs a single access of a service named MMService. In this example, MMService is a member of a genre of services that the identity has not used before and will not be using again. In some examples, the identity's accessing of MMService may cause a machine learning model to change the recommendation for PPService, which has consistently been a retain recommendation in the past, to a deallocate recommendation. However, this may be a poor recommendation because the identity has only accessed MMService once, and the single accessing of MMService should not cause the permission for PPService to be deallocated. In some examples, speculative execution of the machine learning model may reveal that, if the identity had not performed the single access of MMService, the recommendation for PPService would have stayed as a retain recommendation and would not be changed to deallocate. Based on this information, which may be included in change conditions 703, it may be determined that the machine learning model 701 should not recommend deallocation of PPService and should continue to recommend retaining PPService. In this and other scenarios, speculative execution may prevent machine learning model 701 from making inconsistent recommendations, thereby improving the consistency and reliability of machine learning model 701.

Additionally, in some examples, a new machine learning model may be tested based on speculative execution to confirm that the machine learning model satisfies a selected consistency benchmark. This may occur, for example, during development of the model. In one specific scenario, a consistency benchmark may be employed in which accessing only a single service from a given genre one time should not change the model's recommendations. In some examples, access patterns for a set of identities may be randomly sampled and evaluated by the model to make corresponding recommendations for testing purposes. For each identity in the sample, speculative execution may simulate a hypothetical scenario in which the identity had accessed only a single service from a given genre one time. In each case, in order to meet the benchmark, having accessed only a single service from a given genre one time should not change the model's recommendation. If the model fails the benchmark (i.e., if the recommendation changes), then the new model may not yet be consistent enough to be deployed, and further development may be required to improve the model.

Referring back to FIG. 7, it is also shown that speculative execution may be used to improve efficiency of the recommendations process, for example by providing change conditions 703 to permissions updater 708. The permissions updater 708 determines when the machine learning model 701 is to evaluate (or reevaluate) permissions for an identity. For example, one simple approach that could be employed is to have the machine learning model 701 reevaluate recommendations at fixed time periods (e.g., once a day, once a week etc.). However, this is inefficient because the model's recommendations may often stay the same. As described above, speculative execution may identify change conditions 703, which may include future conditions that would cause the identity's recommendations to change. Instead of reevaluating an identity's recommendations at fixed time periods, the permissions updater 708 of machine learning model 701 may instead be configured to only cause reevaluation of an identity's recommendations when the one of the determined future conditions occur that would cause a recommendation to be changed. Similarly, speculative execution may identify future conditions that would not cause the identity's recommendations to change. The permissions updater 708 of machine learning model 701 may then be configured to not cause reevaluation of the identity's recommendations when these conditions occur (and to instead reevaluate the identity's recommendations based on occurrences of other conditions, such as those that will cause the model to change). Enabling selective decision updating is one way in which speculative execution may also be employed for improving the efficiency of temporal machine learning models. It is noted that change conditions 703 of FIG. 7 may vary depending upon their usage. For example, in some cases, when change conditions 703 are only generated for purposes of explaining recommendations to a user, it may be advantageous to determine only a small quantity of change conditions 703, as it may be impractical to attempt to inform the user of every possible condition that could cause a recommendation to change. By contrast, when change conditions 703 are generated for purposes of efficiency (e.g., by providing change conditions 703 to permissions updater 708), it may be advantageous to determine a greater quantity of change conditions 703 (and, in some cases, all change conditions 703) that could cause a recommendation to change, such as to help ensure that the recommendation is reevaluated when appropriate.

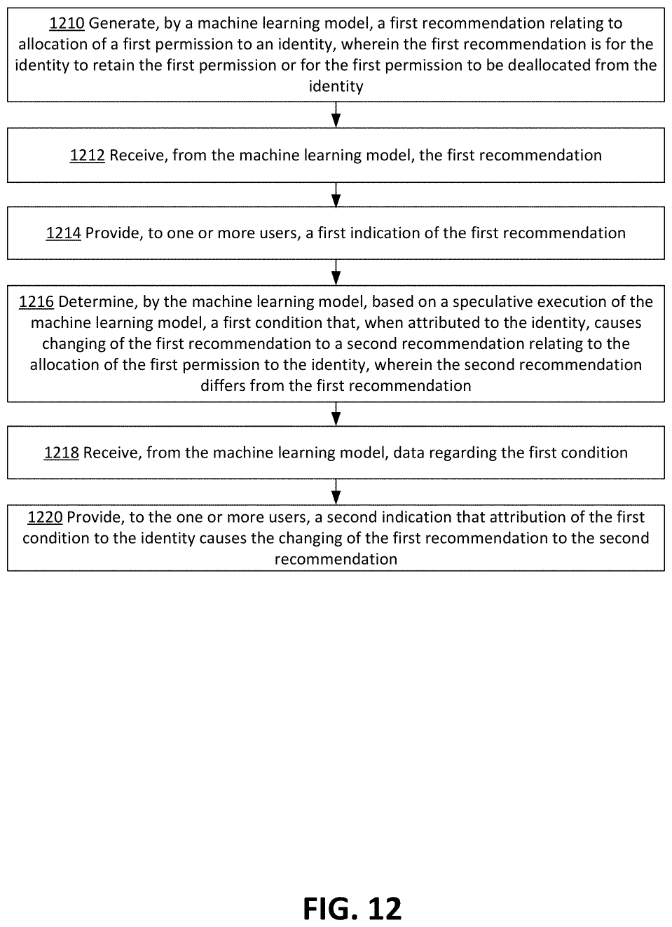

FIG. 12 is a flowchart illustrating an example speculative execution-based permissions recommendations process that may be used in accordance with the present disclosure. The process of FIG. 12 is initiated at operation 1210, at which a first recommendation relating to allocation of a first permission to an identity is generated by a machine learning model, wherein the first recommendation is for the identity to retain the first permission or for the first permission to be deallocated from the identity. For example, FIGS. 9 and 11 both shown examples in which a recommendation is made for the My-Example-Role identity to retain a permission. By contrast, FIGS. 8 and 10 both shown examples in which, a recommendation is made to deallocate a permission from the My-Example-Role identity. As described above, a machine learning model may be employed to make permissions recommendations, for example based on permission usage information. In some examples, as described above with reference to FIG. 6, a permissions recommendation may be made, such as by a machine learning model, by analyzing permission usage information (e.g., operation 614 of FIG. 6), forecasting, based at least in part on the permission usage information, an estimated probability of a future usage of the first permission by an identity (e.g., operation 616 of FIG. 6), and determining, based at least in part on the estimated probability, a first recommendation relating to allocation of the first permission to the identity (e.g., operation 618 of FIG. 6). Descriptions of these operations are provided in detail above and are not repeated here. As also described above, usage pattern data 154 may be determined based at least in part on a machine learning analysis of the identity usage history 151, related identity usage history 152, and/or global usage history 153. The usage pattern data 154 may include for example, patterns of repeat permission usage by an identity. For example, an identity's usage history may be analyzed to determine patterns associated with usage of a permission by the identity. The usage pattern data 154 may also include patterns of permissions that are commonly used together. For example, machine learning components may analyze the global usage history to determine that Permission Y is frequently used in combination with Permission X. This may be helpful in determining when an identity is likely to, in the future, use a permission that the identity has not recently used (or may have never previously used).

At operation 1212, the first recommendation is received from the machine learning model. For example, as shown in FIG. 7, permissions recommendation 702 is received, from machine learning model 701, by decision manager 710. At operation 1214, a first indication of the first recommendation is provided to one or more users. For example, as shown in FIG. 7, recommendation indication 709 is provided to user 707 via user interface 706. As a specific example, field 902 of FIG. 9 shows a first indication that a first recommendation is made for the My-Example-Role identity to retain a permission for XXService. By contrast, field 802 of FIG. 8 shows a first indication that a first recommendation is made to deallocate a permission for WWService from the My-Example-Role identity.

At operation 1216, a first condition is determined, by the machine learning model, based on a speculative execution of the machine learning model, that, when attributed to the identity, causes changing of the first recommendation to a second recommendation relating to the allocation of the first permission to the identity, wherein the second recommendation differs from the first recommendation. In order to determine the first condition, a speculative execution engine of the machine learning model may evaluate one or more theoretical conditions using the methodology of the machine learning model. Evaluation of the one or more theoretical conditions may include any, or all, of the same techniques that are employed to make the first recommendation at operation 1210. However, it is noted that, at operation 1210, the machine learning model may consider only actual conditions, such as may be included in the permission usage history. By contrast, at operation 1216, the machine learning model may consider actual conditions used to make the first recommendation in combination with a past or future theoretical condition that is being evaluated. In some cases, a given theoretical condition may not cause the first permissions recommendation to change. By contrast, in some cases, a given theoretical condition may cause the first permissions recommendation to change. The first condition that is determined at operation 1216 is a theoretical condition that, when attributed to the identity, causes changing of the first recommendation to a second recommendation.

In some examples, the first condition may be a past condition, which is a condition that could have occurred in the past (i.e., prior to determination of the first condition) but which did not actually occur. In some examples, a past condition may correspond to accessing of a service, by the identity, within a past time period. In other examples, the first condition may be a future condition, which is a condition that could occur in the future (i.e., after determination of the first condition) but which may, or may not, actually occur. In some examples, a future condition may correspond to accessing of a service, by the identity, within a future time period.

At operation 1218, data regarding the first condition is received from the machine learning model. For example, as shown in FIG. 7, change conditions 703 are received, from machine learning model 701, by decision manager 710. The first condition is one of the change conditions 703. The data received at operation 1218 may include an identification of the first condition and may also indicate that the first condition, when attributed to the identity, causes changing of the first recommendation to a second recommendation.

At operation 1220, a second indication is provided, to the one or more users, that attribution of the first condition to the identity causes the changing of the first recommendation to the second recommendation. As shown in FIG. 7, change condition indications 704 are provided to user 707 via user interface 706. For example, the second indication that is provided at operation 1220 may include any of indications 803-805 of FIG. 8, any of indications 903-905 of FIG. 9, any of indications 1003-1004 of FIG. 10, or any of indications 1103-1104 of FIG. 11. As a specific example, indication 903 of FIG. 9 indicates that, if My-Example-Role uses DDSevice within the next 15 days, it will cause the recommendation for retaining XXService to change from retain to deallocate. Thus, indication 903 is an example of the second indication that may be provided at operation 1220. As another specific example, indication 803 of FIG. 8 indicates that, if My-Example-Role uses AASevice within the next 15 days, it will cause the recommendation for deallocating WWService to change from deallocate to retain. Thus, indication 803 is another example of the second indication that may be provided at operation 1220.

As described above, in some examples, speculative execution may be used to confirm that the machine learning model satisfies a selected consistency benchmark. Thus, in some examples, the process of FIG. 12 may include an optional additional operation for testing the machine learning model based on one or more other speculative executions to confirm that the machine learning model satisfies a selected consistency benchmark.

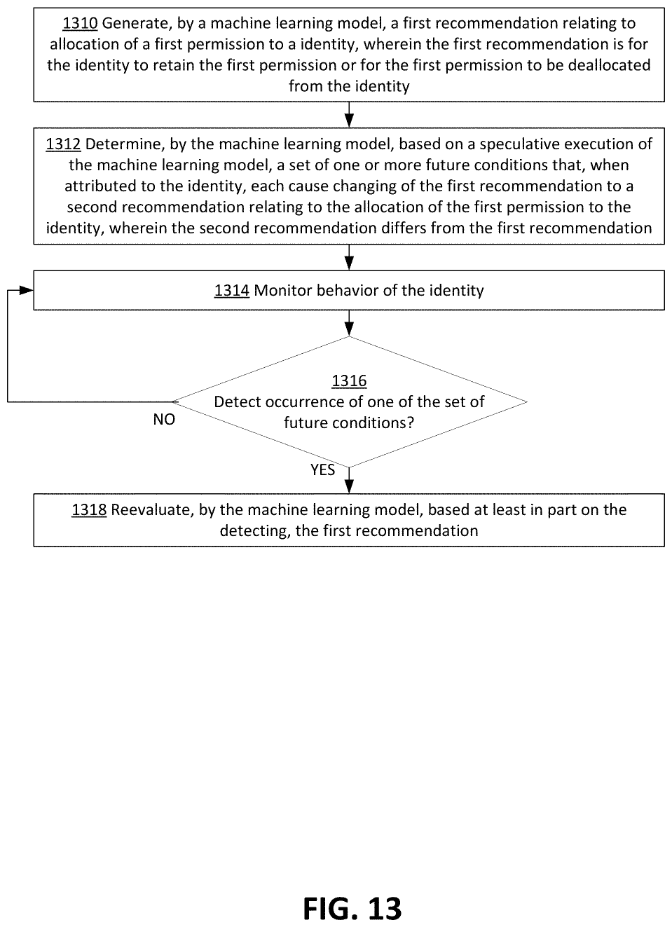

FIG. 13 is a flowchart illustrating an example speculative execution-based permissions reevaluation process that may be used in accordance with the present disclosure. The process of FIG. 13 is initiated at operation 1310, at which a first recommendation relating to allocation of a first permission to an identity is generated by a machine learning model, wherein the first recommendation is for the identity to retain the first permission or for the first permission to be deallocated from the identity. As operation 1310 is identical to operation 1210 of FIG. 12, the description of operation 1210 is not repeated here but may be considered to apply to operation 1310. At operation 1312, a set of one or more future conditions is determined, by the machine learning model, based on a speculative execution of the machine learning model, that, when attributed to the identity, each cause changing of the first recommendation to a second recommendation relating to the allocation of the first permission to the identity, wherein the second recommendation differs from the first recommendation. Operation 1312 is similar to operation 1216, with two exceptions. First, operation 1312 determines only future conditions that would cause the first recommendation to change, while the first condition of operation 1216 may be a future condition or a past condition. Additionally, operation 1312 may identify multiple, and in some cases all, future conditions that would cause the first recommendation to change. As operations 1312 and 1216 are similar, the description from operation 1216 is not repeated here, but may be considered to apply to operation 1312 as modified for the two exceptions mentioned above. It is noted that, if the first condition determined at operation 1216 is a future condition, then the first condition may be included in the set of one or more future conditions determined at operation 1312. In some examples, the future conditions determined at operation 1312 may include accessing a service within a given future time period and/or not accessing a service within a given future time period.

At operation 1314, the behavior of the identity is monitored, such as to detect when one of the set of one or more future conditions occurs. For example, monitoring of the behavior of the first identity may include determining when the first identity accesses one or more services and/or resources. In some examples, accessing of one or more services and/or resources by the identity may be indicated in identity usage history 151, such as by identifying the services and/or resources that were accessed along with the time of access and optionally other metadata. Thus, in some examples, operation 1314 may include periodically analyzing updates to identity usage history 151, such to identify the services and/or resources that identity has (and/or has not) accessed in any given time periods.

At operation 1316, it is determined whether an occurrence of one of the set of one or more future conditions is detected. In some examples, a condition may be detected (or not detected) based on analyzing of identity usage history 151 to determine which services and/or resources have been accessed (and/or not accessed) by the identity in any given time periods. If none of the future conditions in the set of future conditions are detected, then the process may return to operation 1314.

By contrast, if one or more of the future conditions in the set of future conditions are detected, then the process proceeds to operation 1314, at which the first recommendation is reevaluated, by the machine learning model, based at least in part on the detecting. Reevaluating of the first recommendation may include a re-performance of operation 1310, and the description of operation 1310 is not repeated here. Reevaluating of the first recommendation may cause the first recommendation to be changed to the second recommendation, which may include changing of a retain recommendation to a deallocate recommendation or changing of a deallocate recommendation to a retain recommendation. Thus, as shown in the example process of FIG. 13, speculative execution may be used to improve efficiency of the recommendations process. As described above, one simple approach that could be employed is to have the machine learning model reevaluate recommendations at fixed time periods (e.g., once a day, once a week etc.). However, this is inefficient because the model's recommendations may often stay the same. As described in the example process of FIG. 13, speculative execution may identify future conditions that would cause the identity's recommendations to change. Instead of reevaluating an identity's recommendations at fixed time periods, the machine learning model may instead be configured to only reevaluate an identity's recommendations when the one of the determined future conditions occur that would cause a recommendation to be changed.

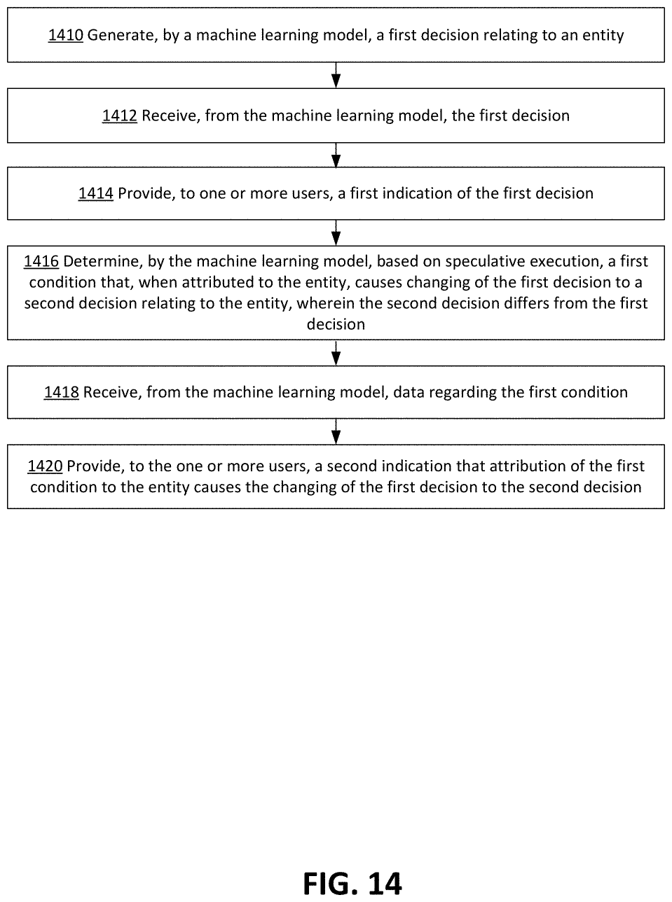

FIG. 14 is a flowchart illustrating an example speculative execution-based model decision process that may be used in accordance with the present disclosure. The process of FIG. 14 is initiated at operation 1410, at which a first decision relating to an entity is generated by a machine learning model. As described above, in some examples, an identity may be one type of entity, and a permissions recommendation is one type of decision that may be made by a machine learning model. In some examples, as described above with reference to FIG. 6, a permissions recommendation may be made, such as by a machine learning model, by analyzing permission usage information (e.g., operation 614 of FIG. 6), forecasting, based at least in part on the permission usage information, an estimated probability of a future usage of the first permission by an identity (e.g., operation 616 of FIG. 6), and determining, based at least in part on the estimated probability, a first recommendation relating to allocation of the first permission to the identity (e.g., operation 618 of FIG. 6). As also described above, however, machine learning models may also be employed to make many other types of decisions for many other types of entities. For example, while permissions recommendations are one type of decision, machine learning models may be employed to make many other types of decisions, such as decisions regarding fraud detection, retail and other sales forecasting, price fluctuations for stocks and other assets, recommendations of new products and features for customers, and the like.

As described above, in some examples, machine learning models may generate decisions by analyzing behaviors of one or more entities (e.g., by analyzing a history of actions performed by the entities), determining one or more behavior patterns for the entities, at least partially matching and/or correlating observed behavior patterns with one or more training patterns that may be determined by the machine learning model based on training data, and then generating a decision based at least in part on the correlation between the observed behavior patterns and the training behavior patterns. For example, for video streaming services, machine learning models may be employed to generate decisions regarding recommended videos that a customer might like to view. In some examples, the machine learning model may make these decisions based at least in part on prior genres of videos that the viewer has watched in the past. For example, if a viewer has a history of viewing primarily dramas, then the machine learning model may recommend new dramas to the viewer. By contrast, if the viewer has a history of viewing primarily documentaries, then the machine learning model may recommend new documentaries to the viewer. As another example, suppose that the viewer has a history of watching sports on Saturdays and watching comedies on Sundays. In some examples, the machine learning model could detect these patterns and recommend new sports videos to the viewer on Saturdays and recommend new comedy videos to the viewer on Sundays. As yet another example, suppose that a viewer has viewed all sports videos in the past. Now suppose that training data indicates that viewers of sports videos tend to like a certain action movie. Based on this training data pattern, the machine learning model could recommend this action movie to the viewer, even though the viewer hasn't watched action movies in the past.

At operation 1412, the first decision is received from the machine learning model. For example, as shown in FIG. 7, permissions recommendation 702 is received, from machine learning model 701, by decision manager 710. Decision manager 710 (or another similar component) may also be employed to receive other types of decisions, such as video recommendations for viewers, from a machine learning model. At operation 1414, a first indication of the first decision is provided to one or more users. For example, as shown in FIG. 7, recommendation indication 709 is provided to user 707 via user interface 706. Other types of decisions may also be provided to users via a user interface. For example, a user interface could be employed by a video streaming service to display recommends of new videos to viewers.

At operation 1416, a first condition is determined, by the machine learning model, based on a speculative execution of the machine learning model, that, when attributed to the entity, causes changing of the first decision to a second decision relating to the entity, wherein the second decision differs from the first decision. In order to determine the first condition, a speculative execution engine of the machine learning model may evaluate one or more theoretical conditions using the methodology of the machine learning model. Evaluation of the one or more theoretical conditions may include any, or all, of the same techniques that are employed to make the first decision at operation 1410. However, it is noted that, at operation 1410, the machine learning model may consider only actual conditions, such as may be included in a behavior history log of the entity. By contrast, at operation 1416, the machine learning model may consider actual conditions used to make the first decision in combination with a past or future theoretical condition that is being evaluated. In some cases, a given theoretical condition may not cause the first decision to change. By contrast, in some cases, a given theoretical condition may cause the first decision to change. The first condition that is determined at operation 1414 is a theoretical condition that, when attributed to the entity, causes changing of the first decision to a second decision. In some examples, the first condition may be a past condition, which is a condition that could have occurred in the past (i.e., prior to determination of the first condition) but which did not actually occur. In other examples, the first condition may be a future condition, which is a condition that could occur in the future (i.e., after determination of the first condition) but which may, or may not, actually occur.

At operation 1418, data regarding the first condition is received from the machine learning model. For example, as shown in FIG. 7, change conditions 703 are received, from machine learning model 701, by decision manager 710. Although FIG. 7 relates to permissions recommendations, it should be appreciated that decision manager 710 (or another similar component) may also be employed to receive data regarding other types of decisions from a machine learning model. The data received at operation 1418 may include an identification of the first condition and may also indicate that the first condition, when attributed to the entity, causes changing of the first decision to the second decision.

At operation 1420, a second indication is provided, to the one or more users, that attribution of the first condition to the entity causes the changing of the first decision to the second decision. As shown in FIG. 7, change condition indications 704 are provided to user 707 via user interface 706. Although FIG. 7 relates to permissions recommendations, it should be appreciated that other types of decisions may also be provided to users, for example by being displayed in a user interface. For example, consider a scenario in which a viewer has watched only three comedy videos in the past, which are videos C1, C2, and C3. Based on this viewing history, a first decision could be generated, at operation 1410, to recommend a new comedy video, C4, to the viewer. However, at operation 1416, it may be determined that, if a viewer had watched a documentary video, D1, in the past, that the recommendation would change to recommending a new documentary video, D2, to the viewer instead of C4. In this example, at operation 1420, an indication may be provided to the viewer, such as text that states, “if you had watched D1 in the past, then we would have recommended D2 instead of C4.” As yet another example, suppose that another available comedy video, C5, includes a particular actor A1. Now suppose that a new sports video, S1, includes the same actor A1. In this scenario, at operation 1416, it may be determined that, if the viewer watches C5 in the future, that the recommendation would change to recommending S1 to the viewer instead of C4. In this example, at operation 1420, an indication may be provided to the viewer, such as text that states, “if you watch C5 in the future, then we will change our recommendation to S1 instead of C4.”

As described above, in some examples, speculative execution may be used to confirm that the machine learning model satisfies a selected consistency benchmark. Thus, in some examples, the process of FIG. 14 may include an optional additional operation for testing the machine learning model based on one or more other speculative executions to confirm that the machine learning model satisfies a selected consistency benchmark.

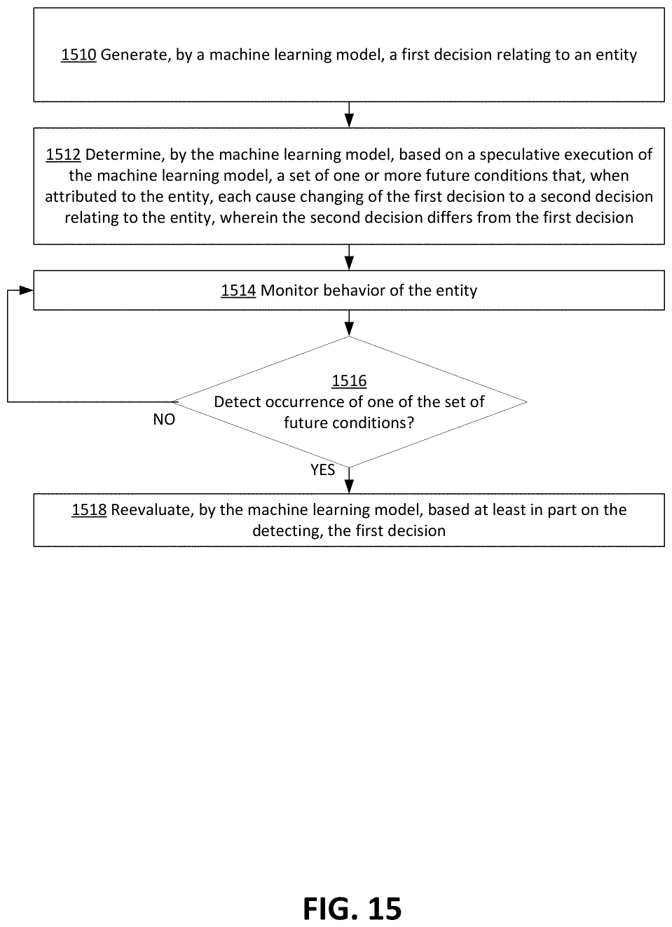

FIG. 15 is a flowchart illustrating an example speculative execution-based decision reevaluation process that may be used in accordance with the present disclosure. The process of FIG. 15 is initiated at operation 1510, at which a first decision relating to an entity is generated by a machine learning model. As operation 1510 is identical to operation 1410 of FIG. 14, the description of operation 1410 is not repeated here but may be considered to apply to operation 1510. At operation 1512, a set of one or more future conditions is determined, by the machine learning model, based on a speculative execution of the machine learning model, that, when attributed to the entity, each cause changing of the first decision to a second decision relating to the entity, wherein the second decision differs from the first decision. Operation 1512 is similar to operation 1416, with two exceptions. First, operation 1512 determines only future conditions that would cause the first decision to change, while the first condition of operation 1416 may be a future condition or a past condition. Additionally, operation 1512 may identify multiple, and in some cases all, future conditions that would cause the first decision to change. As operations 1512 and 1416 are similar, the description from operation 1416 is not repeated here, but may be considered to apply to operation 1512 as modified for the two exceptions mentioned above. It is noted that, if the first condition determined at operation 1416 is a future condition, then the first condition may be included in the set of one or more future conditions determined at operation 1512.

At operation 1514, the behavior of the entity is monitored, such as to detect when one of the set of one or more future conditions occurs. For example, for the video recommendations system described above, monitoring of the behavior of the first entity may include determining when the viewer watches one or more videos. In some examples, the behaviors and/or actions of the entity may be recorded in an entity behavior history log. For example, a video viewer history log may record titles and genres of videos that are watched by a viewer along with the time of viewing and optionally other metadata. Thus, in some examples, operation 1514 may include periodically analyzing updates to an entity behavior history, such to identify actions (e.g., viewing of videos) that an entity has (and/or has not) performed in any given time periods.

At operation 1516, it is determined whether an occurrence of one of the set of one or more future conditions is detected. In some examples, a condition may be detected (or not detected) based on analyzing of an entity behavior history to determine which actions (e.g., viewing of videos) an entity has (and/or has not) performed in any given time periods. If none of the future conditions in the set of future conditions are detected, then the process may return to operation 1514.

By contrast, if one or more of the future conditions in the set of future conditions are detected, then the process proceeds to operation 1514, at which the first decision is reevaluated, by the machine learning model, based at least in part on the detecting. Reevaluating of the first decision may include a re-performance of operation 1510, and the description of operation 1510 is not repeated here. Reevaluating of the first decision may cause the first decision to be changed to the second decision, such as changing a video watching recommendation from one type of video (e.g., a drama video) to another (e.g., a sports video). Thus, as shown in the example process of FIG. 15, speculative execution may be used to improve efficiency of the decision process. As described above, one simple approach that could be employed is to have the machine learning model reevaluate decisions at fixed time periods (e.g., once a day, once a week etc.). However, this is inefficient because the model's decisions may often stay the same. As described in the example process of FIG. 15, speculative execution may identify future conditions that would cause the entity's decisions to change. Instead of reevaluating an entity's decisions at fixed time periods, the machine learning model may instead be configured to only reevaluate an entity's decisions when the one of the determined future conditions occur that would cause a decision to be changed.

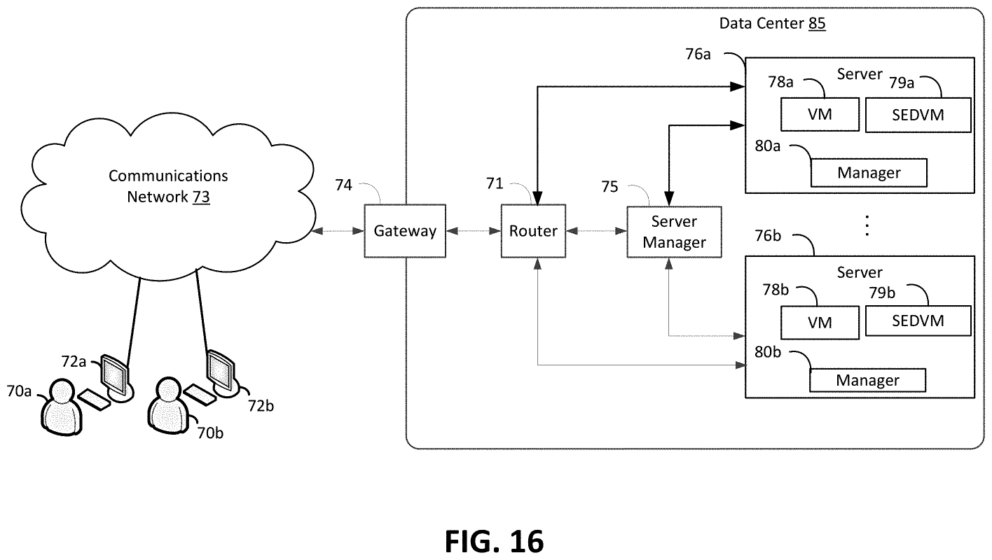

An example system for transmitting and providing data will now be described in detail. In particular, FIG. 16 illustrates an example computing environment in which the embodiments described herein may be implemented. FIG. 16 is a diagram schematically illustrating an example of a data center 85 that can provide computing resources to users 70a and 70b (which may be referred herein singularly as user 70 or in the plural as users 70) via user computers 72a and 72b (which may be referred herein singularly as computer 72 or in the plural as computers 72) via a communications network 73. Data center 85 may be configured to provide computing resources for executing applications on a permanent or an as-needed basis. The computing resources provided by data center 85 may include various types of resources, such as gateway resources, load balancing resources, routing resources, networking resources, computing resources, volatile and non-volatile memory resources, content delivery resources, data processing resources, data storage resources, data communication resources and the like. Each type of computing resource may be available in a number of specific configurations. For example, data processing resources may be available as virtual machine instances that may be configured to provide various web services. In addition, combinations of resources may be made available via a network and may be configured as one or more web services. The instances may be configured to execute applications, including web services, such as application services, media services, database services, processing services, gateway services, storage services, routing services, security services, encryption services, load balancing services, application services and the like. These services may be configurable with set or custom applications and may be configurable in size, execution, cost, latency, type, duration, accessibility and in any other dimension. These web services may be configured as available infrastructure for one or more clients and can include one or more applications configured as a platform or as software for one or more clients. These web services may be made available via one or more communications protocols. These communications protocols may include, for example, hypertext transfer protocol (HTTP) or non-HTTP protocols. These communications protocols may also include, for example, more reliable transport layer protocols, such as transmission control protocol (TCP), and less reliable transport layer protocols, such as user datagram protocol (UDP). Data storage resources may include file storage devices, block storage devices and the like.

Each type or configuration of computing resource may be available in different sizes, such as large resources—consisting of many processors, large amounts of memory and/or large storage capacity—and small resources—consisting of fewer processors, smaller amounts of memory and/or smaller storage capacity. Customers may choose to allocate a number of small processing resources as web servers and/or one large processing resource as a database server, for example.

Data center 85 may include servers 76a and 76b (which may be referred herein singularly as server 76 or in the plural as servers 76) that provide computing resources. These resources may be available as bare metal resources or as virtual machine instances 78a-b (which may be referred herein singularly as virtual machine instance 78 or in the plural as virtual machine instances 78). In this example, the resources also include speculative execution decision virtual machines (SEDVM's) 79a-b, which are virtual machines that are configured to execute any, or all, of the speculative execution-based machine learning model decision techniques described herein, such as to use speculative execution to determine conditions that will change a machine learning model's decisions as described above.

The availability of virtualization technologies for computing hardware has afforded benefits for providing large scale computing resources for customers and allowing computing resources to be efficiently and securely shared between multiple customers. For example, virtualization technologies may allow a physical computing device to be shared among multiple users by providing each user with one or more virtual machine instances hosted by the physical computing device. A virtual machine instance may be a software emulation of a particular physical computing system that acts as a distinct logical computing system. Such a virtual machine instance provides isolation among multiple operating systems sharing a given physical computing resource. Furthermore, some virtualization technologies may provide virtual resources that span one or more physical resources, such as a single virtual machine instance with multiple virtual processors that span multiple distinct physical computing systems.

Referring to FIG. 16, communications network 73 may, for example, be a publicly accessible network of linked networks and possibly operated by various distinct parties, such as the Internet. In other embodiments, communications network 73 may be a private network, such as a corporate or university network that is wholly or partially inaccessible to non-privileged users. In still other embodiments, communications network 73 may include one or more private networks with access to and/or from the Internet.

Communication network 73 may provide access to computers 72. User computers 72 may be computers utilized by users 70 or other customers of data center 85. For instance, user computer 72a or 72b may be a server, a desktop or laptop personal computer, a tablet computer, a wireless telephone, a personal digital assistant (PDA), an e-book reader, a game console, a set-top box or any other computing device capable of accessing data center 85. User computer 72a or 72b may connect directly to the Internet (e.g., via a cable modem or a Digital Subscriber Line (DSL)). Although only two user computers 72a and 72b are depicted, it should be appreciated that there may be multiple user computers.

User computers 72 may also be utilized to configure aspects of the computing resources provided by data center 85. In this regard, data center 85 might provide a gateway or web interface through which aspects of its operation may be configured through the use of a web browser application program executing on user computer 72. Alternately, a stand-alone application program executing on user computer 72 might access an application programming interface (API) exposed by data center 85 for performing the configuration operations. Other mechanisms for configuring the operation of various web services available at data center 85 might also be utilized.

Servers 76 shown in FIG. 16 may be servers configured appropriately for providing the computing resources described above and may provide computing resources for executing one or more web services and/or applications. In one embodiment, the computing resources may be virtual machine instances 78. In the example of virtual machine instances, each of the servers 76 may be configured to execute an instance manager 80a or 80b (which may be referred herein singularly as instance manager 80 or in the plural as instance managers 80) capable of executing the virtual machine instances 78. The instance managers 80 may be a virtual machine monitor (VMM) or another type of program configured to enable the execution of virtual machine instances 78 on server 76, for example. As discussed above, each of the virtual machine instances 78 may be configured to execute all or a portion of an application.

It should be appreciated that although the embodiments disclosed above discuss the context of virtual machine instances, other types of implementations can be utilized with the concepts and technologies disclosed herein. For example, the embodiments disclosed herein might also be utilized with computing systems that do not utilize virtual machine instances.

In the example data center 85 shown in FIG. 16, a router 71 may be utilized to interconnect the servers 76a and 76b. Router 71 may also be connected to gateway 74, which is connected to communications network 73. Router 71 may be connected to one or more load balancers, and alone or in combination may manage communications within networks in data center 85, for example, by forwarding packets or other data communications as appropriate based on characteristics of such communications (e.g., header information including source and/or destination addresses, protocol identifiers, size, processing requirements, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

In the example data center 85 shown in FIG. 16, a server manager 75 is also employed to at least in part direct various communications to, from and/or between servers 76a and 76b. While FIG. 16 depicts router 71 positioned between gateway 74 and server manager 75, this is merely an exemplary configuration. In some cases, for example, server manager 75 may be positioned between gateway 74 and router 71. Server manager 75 may, in some cases, examine portions of incoming communications from user computers 72 to determine one or more appropriate servers 76 to receive and/or process the incoming communications. Server manager 75 may determine appropriate servers to receive and/or process the incoming communications based on factors such as an identity, location or other attributes associated with user computers 72, a nature of a task with which the communications are associated, a priority of a task with which the communications are associated, a duration of a task with which the communications are associated, a size and/or estimated resource usage of a task with which the communications are associated and many other factors. Server manager 75 may, for example, collect or otherwise have access to state information and other information associated with various tasks in order to, for example, assist in managing communications and other operations associated with such tasks.

It should be appreciated that the network topology illustrated in FIG. 16 has been greatly simplified and that many more networks and networking devices may be utilized to interconnect the various computing systems disclosed herein. These network topologies and devices should be apparent to those skilled in the art.

It should also be appreciated that data center 85 described in FIG. 16 is merely illustrative and that other implementations might be utilized. It should also be appreciated that a server, gateway or other computing device may comprise any combination of hardware or software that can interact and perform the described types of functionality, including without limitation: desktop or other computers, database servers, network storage devices and other network devices, PDAs, tablets, cellphones, wireless phones, pagers, electronic organizers, Internet appliances, television-based systems (e.g., using set top boxes and/or personal/digital video recorders) and various other consumer products that include appropriate communication capabilities.

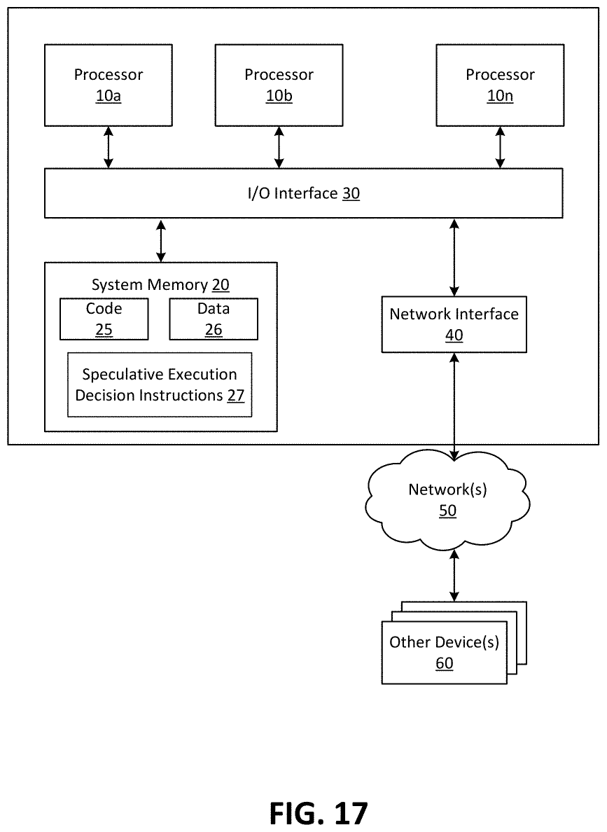

In at least some embodiments, a server that implements a portion or all of one or more of the technologies described herein may include a computer system that includes or is configured to access one or more computer-accessible media. FIG. 17 depicts a computer system that includes or is configured to access one or more computer-accessible media. In the illustrated embodiment, computing device 15 includes one or more processors 10a, 10b and/or 10n (which may be referred herein singularly as “a processor 10” or in the plural as “the processors 10”) coupled to a system memory 20 via an input/output (I/O) interface 30. Computing device 15 further includes a network interface 40 coupled to I/O interface 30.

In various embodiments, computing device 15 may be a uniprocessor system including one processor 10 or a multiprocessor system including several processors 10 (e.g., two, four, eight or another suitable number). Processors 10 may be any suitable processors capable of executing instructions. For example, in various embodiments, processors 10 may be embedded processors implementing any of a variety of instruction set architectures (ISAs), such as the x86, PowerPC, SPARC or MIPS ISAs or any other suitable ISA. In multiprocessor systems, each of processors 10 may commonly, but not necessarily, implement the same ISA.

System memory 20 may be configured to store instructions and data accessible by processor(s) 10. In various embodiments, system memory 20 may be implemented using any suitable memory technology, such as static random access memory (SRAM), synchronous dynamic RAM (SDRAM), nonvolatile/Flash®-type memory or any other type of memory. In the illustrated embodiment, program instructions and data implementing one or more desired functions, such as those methods, techniques and data described above, are shown stored within system memory 20 as code 25 and data 26. Additionally, in this example, system memory 20 includes speculative execution decision instructions 27, which are instructions for executing any, or all, of the speculative execution-based machine learning model decision techniques described herein, such as to use speculative execution to determine conditions that will change a machine learning model's decisions as described above.

In one embodiment, I/O interface 30 may be configured to coordinate I/O traffic between processor 10, system memory 20 and any peripherals in the device, including network interface 40 or other peripheral interfaces. In some embodiments, I/O interface 30 may perform any necessary protocol, timing or other data transformations to convert data signals from one component (e.g., system memory 20) into a format suitable for use by another component (e.g., processor 10). In some embodiments, I/O interface 30 may include support for devices attached through various types of peripheral buses, such as a variant of the Peripheral Component Interconnect (PCI) bus standard or the Universal Serial Bus (USB) standard, for example. In some embodiments, the function of I/O interface 30 may be split into two or more separate components, such as a north bridge and a south bridge, for example. Also, in some embodiments some or all of the functionality of I/O interface 30, such as an interface to system memory 20, may be incorporated directly into processor 10.

Network interface 40 may be configured to allow data to be exchanged between computing device 15 and other device or devices 60 attached to a network or networks 50, such as other computer systems or devices, for example. In various embodiments, network interface 40 may support communication via any suitable wired or wireless general data networks, such as types of Ethernet networks, for example. Additionally, network interface 40 may support communication via telecommunications/telephony networks, such as analog voice networks or digital fiber communications networks, via storage area networks such as Fibre Channel SANs (storage area networks) or via any other suitable type of network and/or protocol.

In some embodiments, system memory 20 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media, such as magnetic or optical media—e.g., disk or DVD/CD coupled to computing device 15 via I/O interface 30. A non-transitory computer-accessible storage medium may also include any volatile or non-volatile media, such as RAM (e.g., SDRAM, DDR SDRAM, RDRAM, SRAM, etc.), ROM (read only memory) etc., that may be included in some embodiments of computing device 15 as system memory 20 or another type of memory. Further, a computer-accessible medium may include transmission media or signals such as electrical, electromagnetic or digital signals conveyed via a communication medium, such as a network and/or a wireless link, such as those that may be implemented via network interface 40.

A network set up by an entity, such as a company or a public sector organization, to provide one or more web services (such as various types of cloud-based computing or storage) accessible via the Internet and/or other networks to a distributed set of clients may be termed a provider network. Such a provider network may include numerous data centers hosting various resource pools, such as collections of physical and/or virtualized computer servers, storage devices, networking equipment and the like, needed to implement and distribute the infrastructure and web services offered by the provider network. The resources may in some embodiments be offered to clients in various units related to the web service, such as an amount of storage capacity for storage, processing capability for processing, as instances, as sets of related services and the like. A virtual computing instance may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

A compute node, which may be referred to also as a computing node, may be implemented on a wide variety of computing environments, such as commodity-hardware computers, virtual machines, web services, computing clusters and computing appliances. Any of these computing devices or environments may, for convenience, be described as compute nodes.

A number of different types of computing devices may be used singly or in combination to implement the resources of the provider network in different embodiments, for example computer servers, storage devices, network devices and the like. In some embodiments a client or user may be provided direct access to a resource instance, e.g., by giving a user an administrator login and password. In other embodiments the provider network operator may allow clients to specify execution requirements for specified client applications and schedule execution of the applications on behalf of the client on execution platforms (such as application server instances, Java′ virtual machines (JVMs), general-purpose or special-purpose operating systems, platforms that support various interpreted or compiled programming languages such as Ruby, Perl, Python, C, C++ and the like or high-performance computing platforms) suitable for the applications, without, for example, requiring the client to access an instance or an execution platform directly. A given execution platform may utilize one or more resource instances in some implementations; in other implementations, multiple execution platforms may be mapped to a single resource instance.

In many environments, operators of provider networks that implement different types of virtualized computing, storage and/or other network-accessible functionality may allow customers to reserve or purchase access to resources in various resource acquisition modes. The computing resource provider may provide facilities for customers to select and launch the desired computing resources, deploy application components to the computing resources and maintain an application executing in the environment. In addition, the computing resource provider may provide further facilities for the customer to quickly and easily scale up or scale down the numbers and types of resources allocated to the application, either manually or through automatic scaling, as demand for or capacity requirements of the application change. The computing resources provided by the computing resource provider may be made available in discrete units, which may be referred to as instances. An instance may represent a physical server hardware platform, a virtual machine instance executing on a server or some combination of the two. Various types and configurations of instances may be made available, including different sizes of resources executing different operating systems (OS) and/or hypervisors, and with various installed software applications, runtimes and the like. Instances may further be available in specific availability zones, representing a logical region, a fault tolerant region, a data center or other geographic location of the underlying computing hardware, for example. Instances may be copied within an availability zone or across availability zones to improve the redundancy of the instance, and instances may be migrated within a particular availability zone or across availability zones. As one example, the latency for client communications with a particular server in an availability zone may be less than the latency for client communications with a different server. As such, an instance may be migrated from the higher latency server to the lower latency server to improve the overall client experience.

In some embodiments the provider network may be organized into a plurality of geographical regions, and each region may include one or more availability zones. An availability zone (which may also be referred to as an availability container) in turn may comprise one or more distinct locations or data centers, configured in such a way that the resources in a given availability zone may be isolated or insulated from failures in other availability zones. That is, a failure in one availability zone may not be expected to result in a failure in any other availability zone. Thus, the availability profile of a resource instance is intended to be independent of the availability profile of a resource instance in a different availability zone. Clients may be able to protect their applications from failures at a single location by launching multiple application instances in respective availability zones. At the same time, in some implementations inexpensive and low latency network connectivity may be provided between resource instances that reside within the same geographical region (and network transmissions between resources of the same availability zone may be even faster).

As set forth above, content may be provided by a content provider to one or more clients. The term content, as used herein, refers to any presentable information, and the term content item, as used herein, refers to any collection of any such presentable information. A content provider may, for example, provide one or more content providing services for providing content to clients. The content providing services may reside on one or more servers. The content providing services may be scalable to meet the demands of one or more customers and may increase or decrease in capability based on the number and type of incoming client requests. Portions of content providing services may also be migrated to be placed in positions of reduced latency with requesting clients. For example, the content provider may determine an “edge” of a system or network associated with content providing services that is physically and/or logically closest to a particular client. The content provider may then, for example, “spin-up,” migrate resources or otherwise employ components associated with the determined edge for interacting with the particular client. Such an edge determination process may, in some cases, provide an efficient technique for identifying and employing components that are well suited to interact with a particular client, and may, in some embodiments, reduce the latency for communications between a content provider and one or more clients.

In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A computing system comprising:
one or more processors; and
one or more memories having stored therein instructions that, upon execution by the one or more processors, cause the computing system to perform operations comprising:
generating, by a machine learning model, a first recommendation relating to allocation of a first permission to an identity, wherein the first recommendation is for the identity to retain the first permission or for the first permission to be deallocated from the identity;
providing, to one or more users, a first indication of the first recommendation;
determining, based on a speculative execution of the machine learning model, a first condition that, when attributed to the identity, causes changing of the first recommendation to a second recommendation relating to the allocation of the first permission to the identity, wherein the second recommendation differs from the first recommendation; and
providing, to the one or more users, a second indication that attribution of the first condition to the identity causes the changing of the first recommendation to the second recommendation.

2. The computing system of claim 1, wherein the first condition is included in a set of one or more future conditions that result in the changing of the first recommendation to the second recommendation.

3. The computing system of claim 2, wherein the operations further comprise:
detecting occurrence of one of the set of one or more future conditions; and
reevaluating, by the machine learning model, based at least in part on the detecting, the first recommendation.

4. The computing system of claim 1, wherein the first condition is a past condition.

5. A computer-implemented method comprising:
generating, by a machine learning model, a first recommendation relating to allocation of a first permission to an identity, wherein the first recommendation is for the identity to retain the first permission or for the first permission to be deallocated from the identity;
providing, to one or more users, a first indication of the first recommendation;
determining, by the machine learning model, a first condition that, when attributed to the identity, causes changing of the first recommendation to a second recommendation relating to the allocation of the first permission to the identity, wherein the second recommendation differs from the first recommendation; and
providing, to the one or more users, a second indication that attribution of the first condition to the identity causes the changing of the first recommendation to the second recommendation.

6. The computer-implemented method of claim 5, wherein the first condition is a future condition.

7. The computer-implemented method of claim 6, wherein the future condition corresponds to accessing of a service, by the identity, within a future time period.

8. The computer-implemented method of claim 6, wherein the first condition is included in a set of one or more future conditions that, when attributed to the identity, each cause changing of the first recommendation to the second recommendation.

9. The computer-implemented method of claim 8, further comprising:
detecting occurrence of one of the set of one or more future conditions; and
reevaluating, by the machine learning model, based at least in part on the detecting, the first recommendation.

10. The computer-implemented method of claim 5, wherein the first condition is a past condition.

11. The computer-implemented method of claim 10, wherein the past condition corresponds to accessing of a service, by the identity, within a past time period.

12. The computer-implemented method of claim 5, wherein the machine learning model is tested based on one or more speculative executions to confirm that the machine learning model satisfies a selected consistency benchmark.

13. The computer-implemented method of claim 5, wherein the determining of the first condition is based on a speculative execution of the machine learning model.

14. One or more non-transitory computer-readable storage media having stored thereon computing instructions that, upon execution by one or more computing devices, cause the one or more computing devices to perform operations comprising:
generating, by a machine learning model, a first decision relating to an entity;
providing, to one or more users, a first indication of the first decision;
determining, based on a first speculative execution of the machine learning model, a first condition that, when attributed to the entity, causes changing of the first decision to a second decision relating to the entity, wherein the second decision differs from the first decision; and
providing, to the one or more users, a second indication that attribution of the first condition to the entity causes the changing of the first decision to the second decision.

15. The one or more non-transitory computer-readable storage media of claim 14, wherein the first condition is a future condition.

16. The one or more non-transitory computer-readable storage media of claim 15, wherein the first condition is included in a set of one or more future conditions that result in the changing of the first decision to the second decision.

17. The one or more non-transitory computer-readable storage media of claim 16, wherein the operations further comprise:
detecting occurrence of one of the set of one or more future conditions; and
reevaluating, by the machine learning model, based at least in part on the detecting, the first decision.

18. The one or more non-transitory computer-readable storage media of claim 14, wherein the first condition is a past condition.

19. The one or more non-transitory computer-readable storage media of claim 14, wherein the machine learning model is tested based on one or more other speculative executions to confirm that the machine learning model satisfies a selected consistency benchmark.

20. The one or more non-transitory computer-readable storage media of claim 14, wherein the entity is an identity, and wherein the first decision and the second decision are permissions recommendations relating to allocation of a first permission to the identity.
